(19) United States
(12) Patent Application Publication
(10) Pub. No.: US 2021/0110717 A1
(43) Pub. Date: Apr. 15, 2021

(54) Vehicle-Related Notifications Using Wearable Devices

(71) Applicant: GOOGLE LLC, Mountain View, CA (US)

(72) Inventors: Leonardo GIUSTI, San Francisco, CA (US); Ivan POUPYREV, Sunnyvale, CA (US); Suniti Nina WALIA, Oakland, CA (US)

(73) Assignee: Google LLC, Mountain View, CA (US)

(21) Appl. No.: 16/981,038

(22) PCT Filed: Apr. 18, 2019
(86) PCT No.: PCT/US2019/028111

§ 371 Date: Sep. 15, 2020

Related U.S. Application Data
(60) Provisional application No. 62/659,636, filed on Apr. 18, 2018.

(51) Int. Cl. G08G 1/00; G06F 3/01; G06F 3/044

(52) U.S. Cl. CPC G08G 1/202; G06F 3/016; G06F 3/044; G06F 3/011

(57) ABSTRACT

An interactive object and computing devices are configured to provide vehicle-related notifications and gesture detection to enable user interaction with a vehicle service. A computing system can receive data associated with a status of a vehicle that is providing a vehicle service associated with a user of an interactive object. The computing system can provide one or more output signals to one or more output devices of the interactive object. The one or more output signals are based at least in part on the data associated with the status of the vehicle. The computing system can provide, in response to the one or more output signals, an output response indicative of the status of the vehicle.

### RELATED APPLICATION

This application claims the right of priority to U.S. Provisional Application No. 62/659,636, filed on Apr. 18, 2018, the disclosure of which is hereby incorporated by reference herein in its entirety for all purposes.

### FIELD

The present disclosure relates generally to interactive objects, such as wearable devices, that include input and/or output mechanisms.

### BACKGROUND

Mobile computing devices such as smart phones, tablets, smart watches, etc. have become a part of daily life such that many users find themselves interacting with a mobile device throughout the day. For example, many mobile computing devices provide notifications such as notifications that text messages or phone calls have been received. To receive these notifications, a user typically must locate and observe the mobile computing device in order to listen to an audible notification and/or to observe a visual modification. This type of interaction can prove to be less than desirable as it may require a user to refocus their attention away from a task at hand in order to stay aware of notifications that have been received by the mobile computing device.

Accordingly, there is a need for improved systems and methods for notifications in association with mobile computing devices.

### BRIEF DESCRIPTION OF THE DRAWINGS

Embodiments are described with reference to the following drawings. The same numbers are used throughout the drawings to reference like features and components:

FIG. 1 is an illustration of an example environment in which an interactive textile with multiple electronics modules can be implemented.

FIG. 2 illustrates an example system that includes an interactive object and multiple electronics modules.

FIG. 3 illustrates an example of an interactive object with multiple electronics modules in accordance with one or more implementations.

FIG. 4 illustrates an example of a connector for connecting an external communications module to an interactive object in accordance with one or more implementations.

FIG. 5 is a flowchart depicting an example process in accordance with example embodiments of the present disclosure.

FIG. 6 is a flowchart depicting an example process in accordance with example embodiments of the present disclosure.

FIGS. 7A-7D illustrates an example of a user interaction with a ridesharing service using an interactive object in accordance with example embodiments of the present disclosure.

FIG. 8 is a flowchart depicting an example process in accordance with example embodiments of the present disclosure.

FIG. 9 is a flowchart depicting an example process in accordance with example embodiments of the present disclosure.

FIG. 10 is a flowchart depicting an example process in accordance with example embodiments of the present disclosure.

FIG. 11 illustrates an example of a user interaction with a ridesharing service using an interactive object in accordance with example embodiments of the present disclosure.

FIG. 12 is a flowchart depicting an example process in accordance with example embodiments of the present disclosure.

FIG. 13 is a flowchart depicting an example process in accordance with example embodiments of the present disclosure.

FIG. 14 illustrates an example of a user interaction with a ridesharing service using an interactive object in accordance with example embodiments of the present disclosure.

FIG. 15 is a flowchart depicting an example process in accordance with example embodiments of the present disclosure.

FIG. 16 is a flowchart depicting an example process in accordance with example embodiments of the present disclosure.

FIG. 17 illustrates an example of a graphical user interface in accordance with example embodiments of the present disclosure.

FIG. 18 illustrates an example of a graphical user interface in accordance with example embodiments of the present disclosure.

FIG. 19 illustrates an example of a graphical user interface in accordance with example embodiments of the present disclosure.

FIG. 20 illustrates an example of a flexible haptics device made in accordance with the present disclosure.

FIG. 21 illustrates one embodiment of an interactive garment made in accordance with the present disclosure.

FIG. 22 illustrates a portion of the interactive garment illustrated in FIG. 21.

FIG. 23 illustrates various components of an example computing system that can be implemented as any type of client, server, and/or computing device as described herein.

### DETAILED DESCRIPTION

According to example embodiments of the present disclosure, vehicle-related notifications and gestures are provided that can facilitate ridesharing and other vehicle-related services. By way of example, an interactive textile, integrated into an interactive object such as a wearable garment for example, may be provided to facilitate ridesharing efficiencies by providing convenient context-sensitive signaling to the user regarding the status of a requested ride. In some instances, this may allow a phone or other computing device to remain in a user's pocket, purse, etc., or otherwise out of sight, by eliminating the need for the user to look at their smartphone after they have ordered the ride. It is noted that integration with a smartphone or other computing device remote from the garment is not required. For example, the interactive textile may include an integrated computing device that can perform one or more of the functions described herein.

More particularly, in some examples, different notifications or notification types may be used in accordance with vehicle-related services such as ridesharing. For example, a first type of optical, tactile, audio, haptic, or other signal (such as a cuff-mounted LED lightup) can be emitted when a driver or vehicle comes within a predefined radius (or other general closeness metric) to a location. The location may be a predefined pickup location, the location of the user, the location of the interactive textile, or the location of a computing device external to the interactive textile. A second type of optical or tactile signal (such as a vibration of a cuff-mounted buzzer) can be emitted when the driver or vehicle has arrived at the pickup location.

According to some embodiments, a variety of additional systems and methods are provided. For example, actuated fabric tightening/loosening can be used as one or more of the tactile signals. In one embodiment, an arm or other portion of an interactive garment can provide a mild squeeze signal to the user's arm when the driver or vehicle arrives, in addition to (or as an alternative to) the vibrating cuff button. As another example, there can be a so-called “analog” relationship between the actuated arm squeezing and the location of the driver or vehicle, wherein the fabric tightening/squeezing increases gradually according to the declining distance between the driver or vehicle and the pickup point.

In some embodiments, there can further be provided predefined and/or user-definable garment-actuated communication back to the driver or vehicle according to signals given from the user to their garment. By way of example, providing an upward cuff swipe can trigger a text message to the driver that the user needs another 5 minutes to walk to the pickup location, whereas a sideways cuff swipe can trigger a text message that indicates the user is ready at the pickup location. By way of further example, using an appropriately-sensored garment capable of monitoring arm position relative to the body, the user can raise their arm and wave it over their head to trigger a text message to the driver that says “I can see you,” for example. Other outputs can be triggered in response to user inputs.

In accordance with some implementations, an interactive object may include one or more output devices that generate perceptible outputs for a user of the interactive object. For example, the one or more output devices may include a visual output device such as a light or display (e.g., LED), a tactile or haptic output device such as a haptic motor or haptic speaker, and/or an audio output device such as an audio speaker. The interactive object may include one or more computing devices that are communicatively coupled to the one or more output devices. The one or more computing devices can include one or more processors that are configured to receive data associated with the status of a vehicle that is providing a vehicle service associated with the user of the interactive object. The one or more processors can be configured to provide one or output signals to the one or more output devices based at least in part on the data associated with the status of the vehicle. The one or output devices can be configured to provide an output response indicative of the status of the vehicle in response to the one or more output signals. By way of example, the one or more output devices can provide a first output responses such as a first colored light signal when a vehicle is within a first predetermined distance of the user or the interactive object, and can provide a second output response such as a second colored light signal when a vehicle is within a second predetermined distance of the user or interactive object. In other examples, different haptic responses, optical responses, and/or audible responses can be used.

In accordance with example embodiments, one or more computing devices of an interactive object can be configured to receive data associated with the distance of a vehicle from a user of an interactive object. The distance may be based on a location of the vehicle and/or a driver of the vehicle. In some examples, the distance may be based on a location of the user, the interactive object, or a pickup point associated with the vehicle service. The computing device of the interactive object can generate output signals based on the distance of the vehicle from the user of the interactive object.

In some examples, one or more haptic output devices can provide a variable haptic output response based at least in part on the distance of the vehicle from the user of the interactive object. By way of example, the haptic output device may increase a level of its output as the distance between the vehicle and the user decreases. Such an output can provide haptic feedback to the user that is representative of the distance of the vehicle from the user. In some examples, the variable haptic output response includes a first haptic response level that is provided in response to a first vehicle distance and a second haptic response level that is provided in response to a second vehicle distance. Such a response can provide an analog-like output in response to the decreasing distance between the user and the vehicle. The first vehicle distance can be less than the second vehicle distance. The first haptic level can be less than the second haptic level. Other variable output such as variable volumes of an audio output device and/or variable optical outputs (e.g., different colored LED outputs) for a visual output device can be provided.

In accordance with some implementations, a computing device such as a smart phone, embedded device, connected device, cloud computing device, etc. that is remote from the interactive object can interact with the interactive object to facilitate a ridesharing or other vehicle related service. For example, the computing device can receive data associated with the status of the vehicle that is providing a vehicle service. The vehicle service can be associated with a user of the interactive object. Based on the status of the vehicle, the computing device can determine one or more output responses for one or more output devices of the interactive object. The computing device can transmit one or more control signals to the interactive object. The control signals can trigger or otherwise initiate one or more output responses by the one or more output devices of the interactive object. In other examples, a computing device local to the interactive object can perform these processes.

In some examples, a computing device remote from the interactive object can receive data indicative of movement that is detected by one or more sensors of the interactive object. The data can be sensor data generated by a capacitive touch sensor or an inertial measurement unit of the interactive object in some examples. Additionally or alternatively, the data can include data derived from sensor data such as data indicative of one or more gestures detected by the interactive object. In response to receiving data indicative of the movement associated with the user of the interactive object, the remote computing device can transmit supplemental data to the interactive object. The supplemental data can include data indicative of the vehicle providing the vehicle service to the user. The supplemental data may indicate the vehicle's color, make, model, license plate, etc.

One or more sensors of an interactive object may detect movement associated with a user of the interactive object. The movement may be associated with a touch input provided to a capacitive touch sensor of the interactive object by a user. As another example, the movement may be associated with a motion of the user as detected by the inertial measurement unit. By way of example, a user may provide a gesture input to the capacitive touch sensor such as a swipe. In response, the interactive object may retrieve data associated with the vehicle that is providing a vehicle service. The data can be provided as one or more responses by the one or more output devices of the interactive object. By way of example, the supplemental data may be provided as an audio response by an audio output device. In some examples, a user input to the interactive object may trigger a communication from the interactive object and/or a remote computing device to a vehicle and/or a driver of the vehicle. For example, a user may provide a touch input gesture to the capacitive touch sensor of the interactive garment to trigger a text message or other notification that is sent to the vehicle or driver of the vehicle. The text message may indicate an expected time of arrival of the user at the pickup location. In some examples the text message may be sent from a remote computing device such as a smart phone communicatively coupled to the interactive object. In other examples, the text message may be sent directly from the interactive object. As another example, an inertial measurement unit may detect a waving or other motion of the user while wearing or otherwise in contact with the interactive object. Such a motion to a vehicle or driver of the vehicle may initiate a text message or other notification that is provided to the driver or vehicle.

According to some implementations, a computing system can facilitate vehicle related notifications in association with interactive systems including an interactive object. For example, a computing system can receive data associated with the status of a vehicle that is providing a vehicle service associated with a user of an interactive object. The computing system can provide one or more output signals to one or more output devices of an interactive object. The one or more output signals can be based at least in part on the data associated with the status of the vehicle. In some examples, a computing device of the interactive object can receive the data and provide the one or more output signals. In other examples, a computing device remote from the interactive object can receive the data and provide one or more output signals. One or more output devices of the interactive object can provide an output response indicative of the status of the vehicle in response to the one or more output signals.

In some examples, a first output signal can be provided by a computing device in response to a first vehicle status and a second output signal can be provided in response to a second vehicle status. For instance, a first output signal can be provided in response to a vehicle being within a first threshold distance of the user and a second output signal can be provided in response to the vehicle being within a second threshold distance of the user. An output device of the interactive object can provide a first output response that is indicative of the first status of the vehicle and can provide a second output response indicative of the second status of the vehicle. The first output response can be different from the second output response. By way of example, a visual output device can provide a first visual output such as a first color notification in response to the first vehicle status and can provide a second color notification in response to this can vehicle status. In other examples, a variable haptic response or a variable audible response can be provided based on the distance or status of the vehicle.

In accordance with some implementations, a computing device can receive data indicative of movement associated with a user of an interactive object. The movement can be detected by one or more sensors of the interactive object. The computing system can detect at least one predefined motion (e.g., a touch input gesture or motion gesture) based at least in part on the data indicative of the movement associated with the user. In response to detecting the at least one gesture, the interactive object can receive supplemental data associated with the vehicle. By way of example, a computing device at the interactive object may issue a request to a remote computing device such as a smart phone or cloud computing device for information associated with the vehicle service. In some examples, a computing device remote from the interactive object may issue a request for the supplemental data in response to detecting the at least one gesture. The remote computing device can provide the supplemental data to the interactive object. One or more output devices of the interactive object can provide output signals based on the supplemental data. For example, an audio output device can provide an audio response indicative of the supplemental data associated with the vehicle service.

Various technical effects and benefits are provided in accordance with example embodiments of the disclosed technology. For example, an interactive object may interface with a user's smart phone or other computing device to provide vehicle related notifications so as to remove a necessity of further interaction between the user and the phone with respect to the vehicle service. An interactive object such as a jacket or other garment can receive data from the user smart phone or another computing device and provide vehicle related notifications to the user so that the user does not have to interact with the smart phone. Such an interactive object can enable a more efficient and user-friendly context signaling apparatus than traditional computing devices. In some examples, a user may utilize the first computing device is a smart phone to initiate a vehicle service. In response, an interactive object communicatively coupled to the user computing device may thereafter provide vehicle related notifications to the user such that the user need not interact with smart phone.

In some examples, context-sensitive vehicle related notifications and/or signaling can be used. Such context sensitive signaling can provide enhanced user interaction with a vehicle service. Moreover, such signaling can lead to less distraction by removing the need of a user to repeatedly check the computing device for notifications related to the vehicle service. For instance, user can be notified by a first output response of the interactive object when a vehicle is within a predetermined radius or other distance with respect to the user of the interactive object. The interactive object can provide a second output response when a vehicle has arrived at a pickup point or another location. In this manner, a user can freely work, play, or engage in other activities without the necessity of monitoring smart phone or other device in order to know when a vehicle has arrived or is nearby.

In further examples, an interactive object can receive input from a user, such as from a capacitive touch sensor and/or by monitoring movements with an inertial measurement unit. Such techniques can enable a user to initiate communication with a vehicle and/or driver and/or to cause an output response that includes further information related to the vehicle service. In this manner, an interactive object can provide a more convenient and user friendly manner for a user to initiate communication related to the vehicle service and receive additional information related to the vehicle service. In some examples, an interactive object can initiate one or more actions locally at the interactive object or one or more remote computing devices in response to the input. In some examples, the interactive object may initiate a text message or other notification to a vehicle or a driver of the vehicle in response to user input for the detection of a particular motion. For example, an inertial measurement unit may be used to detect a wave motion of the user's hand and in response, the interactive object or a remote computing device can send a notification to a vehicle or driver of the vehicle. In this manner, the vehicle or the driver of the vehicle can be notified of the user's location or when they are close to the user. In another example, a user may provide an input to the interactive object which can trigger the interactive object to provide an output response including supplemental data related to a vehicle service. For example, a user may provide a swipe in or swipe out motion on the cuff of an interactive object, such as an interactive jacket, to initiate an audio response including details of the vehicle service such as a vehicle make, model, other, license plate number, or other identifying information. Such techniques can improve a user experience, driver experience, as well as improve efficiency related to the vehicle service itself.

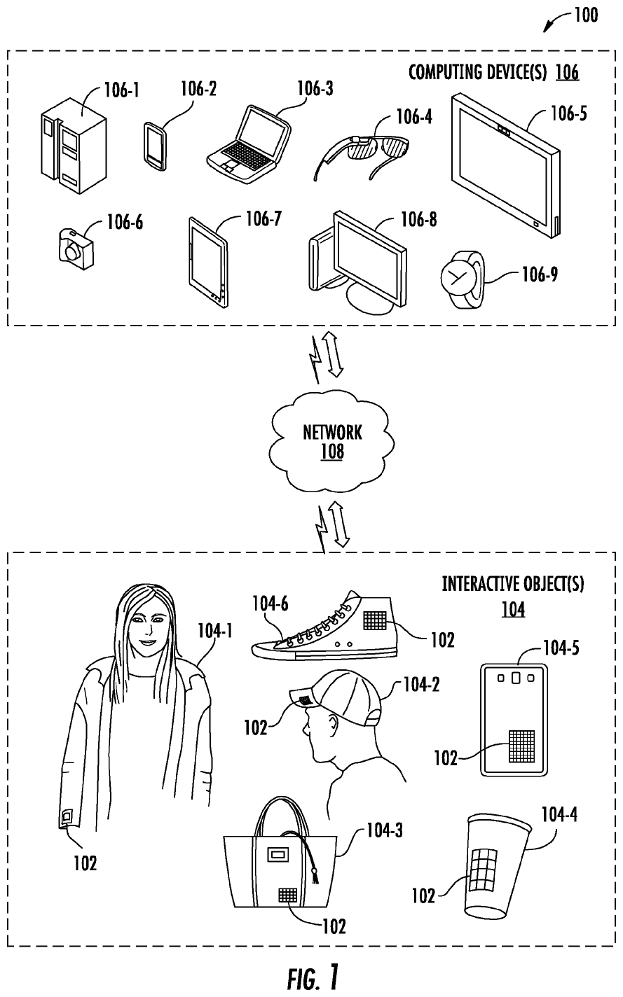

FIG. 1 is an illustration of an example environment 100 in which an interactive object with multiple electronics modules can be implemented. Environment 100 includes a capacitive touch sensor 102. Capacitive touch sensor 102 is shown as being integrated within various interactive objects 104. Capacitive touch sensor 102 may include one or more conductive lines such as conductive threads that are configured to detect a touch input. In some examples, a capacitive touch sensor can be formed from an interactive textile which is a textile that is configured to sense multi-touch-input. As described herein, a textile corresponds to any type of flexible woven material consisting of a network of natural or artificial fibers, often referred to as thread or yarn. Textiles may be formed by weaving, knitting, crocheting, knotting, pressing threads together or consolidating fibers or filaments together in a nonwoven manner. A capacitive touch sensor can be formed from any suitable conductive material and in other manners, such as by using flexible conductive lines including metal lines, filaments, etc. attached to a non-woven substrate.

In environment 100, interactive objects 104 include “flexible” objects, such as a shirt 104-1, a hat 104-2, a handbag 104-3 and a shoe 104-6. It is to be noted, however, that capacitive touch sensor 102 may be integrated within any type of flexible object made from fabric or a similar flexible material, such as garments or articles of clothing, garment accessories, garment containers, blankets, shower curtains, towels, sheets, bed spreads, or fabric casings of furniture, to name just a few. Examples of garment accessories may include sweat-wicking elastic bands to be worn around the head, wrist, or bicep. Other examples of garment accessories may be found in various wrist, arm, shoulder, knee, leg, and hip braces or compression sleeves. Headwear is another example of a garment accessory, e.g. sun visors, caps, and thermal balaclavas. Examples of garment containers may include waist or hip pouches, backpacks, handbags, satchels, hanging garment bags, and totes. Garment containers may be worn or carried by a user, as in the case of a backpack, or may hold their own weight, as in rolling luggage. Capacitive touch sensor 102 may be integrated within flexible objects 104 in a variety of different ways, including weaving, sewing, gluing, and so forth.

In this example, objects 104 further include “hard” objects, such as a plastic cup 104-4 and a hard smart phone casing 104-5. It is to be noted, however, that hard objects 104 may include any type of “hard” or “rigid” object made from non-flexible or semi-flexible materials, such as plastic, metal, aluminum, and so on. For example, hard objects 104 may also include plastic chairs, water bottles, plastic balls, or car parts, to name just a few. In another example, hard objects 104 may also include garment accessories such as chest plates, helmets, goggles, shin guards, and elbow guards. Alternatively, the hard or semi-flexible garment accessory may be embodied by a shoe, cleat, boot, or sandal. Capacitive touch sensor 102 may be integrated within hard objects 104 using a variety of different manufacturing processes. In one or more implementations, injection molding is used to integrate capacitive touch sensors 102 into hard objects 104.

Capacitive touch sensor 102 enables a user to control object 104 that the capacitive touch sensor 102 is integrated with, or to control a variety of other computing devices 106 via a network 108. Computing devices 106 are illustrated with various non-limiting example devices: server 106-1, smart phone 106-2, laptop 106-3, computing spectacles 106-4, television 106-5, camera 106-6, tablet 106-7, desktop 106-8, and smart watch 106-9, though other devices may also be used, such as home automation and control systems, sound or entertainment systems, home appliances, security systems, netbooks, and e-readers. Note that computing device 106 can be wearable (e.g., computing spectacles and smart watches), non-wearable but mobile (e.g., laptops and tablets), or relatively immobile (e.g., desktops and servers).

Network 108 includes one or more of many types of wireless or partly wireless communication networks, such as a local-area-network (LAN), a wireless local-area-network (WLAN), a personal-area-network (PAN), a wide-area-network (WAN), an intranet, the Internet, a peer-to-peer network, point-to-point network, a mesh network, and so forth.

Capacitive touch sensor 102 can interact with computing devices 106 by transmitting touch data through network 108. Computing device 106 uses the touch data to control computing device 106 or applications at computing device 106. As an example, consider that capacitive touch sensor 102 integrated at shirt 104-1 may be configured to control the user's smart phone 106-2 in the user's pocket, television 106-5 in the user's home, smart watch 106-9 on the user's wrist, or various other appliances in the user's house, such as thermostats, lights, music, and so forth. For example, the user may be able to swipe up or down on capacitive touch sensor 102 integrated within the user's shirt 104-1 to cause the volume on television 106-5 to go up or down, to cause the temperature controlled by a thermostat in the user's house to increase or decrease, or to turn on and off lights in the user's house. Note that any type of touch, tap, swipe, hold, or stroke gesture may be recognized by capacitive touch sensor 102.

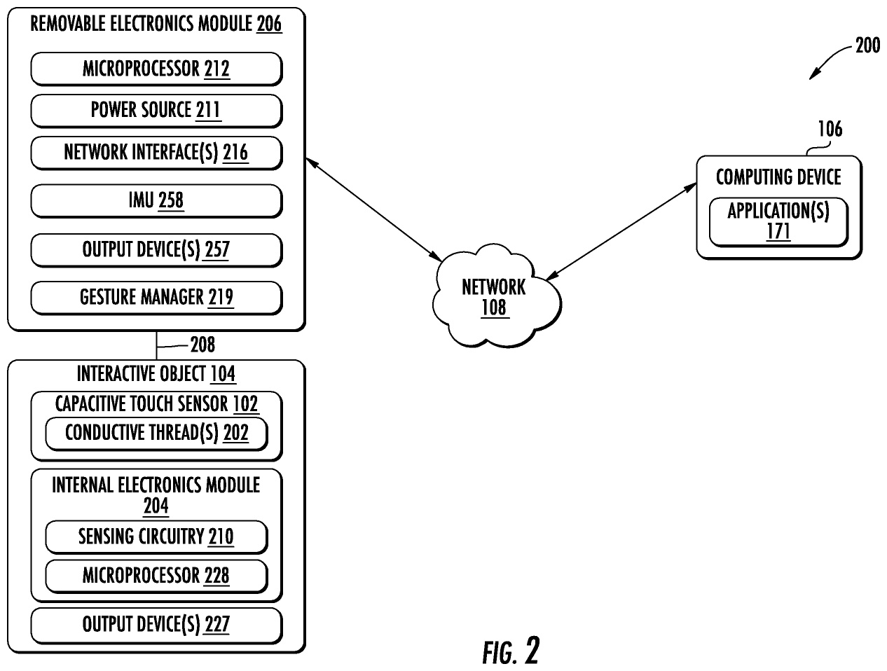

In more detail, consider FIG. 2 which illustrates an example system 200 that includes an interactive object 104 and multiple electronics modules. In system 200, a capacitive touch sensor such as an interactive textile is integrated in an object 104, which may be implemented as a flexible object (e.g., shirt 104-1, hat 104-2, or handbag 104-3) or a hard object (e.g., plastic cup 104-4 or smart phone casing 104-5).

An interactive textile or other flexible conductive material can be configured as a capacitive touch sensor 102 that can sense multi-touch-input from a user when one or more fingers of the user's hand touch the interactive textile. Capacitive touch sensor 102 may also be configured to sense full-hand touch-input from a user, such as when an entire hand of the user touches or swipes the capacitive touch sensor 102. To enable the detection of touch-input, capacitive touch sensor 102 includes conductive threads 202 or other conductive lines, which are woven into an interactive textile or otherwise integrated with a flexible substrate (e.g., in a grid, array or parallel pattern). Notably, the conductive threads 202 do not alter the flexibility of capacitive touch sensor 102, which enables capacitive touch sensor 102 to be easily integrated within interactive objects 104. Although many examples are provided with respect to conductive threads and textiles, it will be appreciated that other conductive lines such as conductive fibers, filaments, sheets, fiber optics and the like may be formed in a similar manner.

Interactive object 104 includes an internal electronics module 204 that is embedded within interactive object 104 and is directly coupled to conductive threads 202. Internal electronics module 204 can be communicatively coupled to a removable electronics module 206 via a communication interface 208. Internal electronics module 204 contains a first subset of electronic components for the interactive object 104, and the removable electronics module 206 contains a second, different, subset of electronics components for the interactive object 104. As described herein, the internal electronics module 204 may be physically and permanently embedded within interactive object 104, whereas the removable electronics module 206 may be removably coupled to interactive object 104. In some examples, the removable electronics module may be referred to as an external electronics module.

In system 200, the electronic components contained within the internal electronics module 204 includes sensing circuitry 210 that is coupled to conductive thread 202 that is woven into the interactive textile. For example, wires from the conductive threads 202 may be connected to sensing circuitry 210 using flexible PCB, creping, gluing with conductive glue, soldering, and so forth. In one embodiment, the sensing circuitry 210 can be configured to detect a user-inputted touch-input on the conductive threads that is pre-programmed to indicate a certain request. In one embodiment, when the conductive threads form a grid or other pattern, sensing circuitry 210 can be configured to also detect the location of the touch-input on conductive thread 202, as well as motion of the touch-input. For example, when an object, such as a user's finger, touches conductive thread 210, the position of the touch can be determined by sensing circuitry 210 by detecting a change in capacitance on the grid or array of conductive thread 202. The touch-input may then be used to generate touch data usable to control computing devices 106. For example, the touch-input can be used to determine various gestures, such as single-finger touches (e.g., touches, taps, and holds), multi-finger touches (e.g., two-finger touches, two-finger taps, two-finger holds, and pinches), single-finger and multi-finger swipes (e.g., swipe up, swipe down, swipe left, swipe right), and full-hand interactions (e.g., touching the textile with a user's entire hand, covering textile with the user's entire hand, pressing the textile with the user's entire hand, palm touches, and rolling, twisting, or rotating the user's hand while touching the textile).

The inertial measurement unit(s) (IMU(s)) 258 can generate sensor data indicative of a position, velocity, and/or an acceleration of the interactive object. The IMU(s) 258 may generate one or more outputs describing one or more three-dimensional motions of the interactive object 104. The IMU(s) may be secured to the internal electronics module 204, for example, with zero degrees of freedom, either removably or irremovably, such that the inertial measurement unit translates and is reoriented as the interactive object 104 is translated and are reoriented. In some embodiments, the inertial measurement unit(s) 258 may include a gyroscope or an accelerometer (e.g., a combination of a gyroscope and an accelerometer), such as a three axis gyroscope or accelerometer configured to sense rotation and acceleration along and about three, generally orthogonal axes. In some embodiments, the inertial measurement unit(s) may include a sensor configured to detect changes in velocity or changes in rotational velocity of the interactive object and an integrator configured to integrate signals from the sensor such that a net movement may be calculated, for instance by a processor of the inertial measurement unit, based on an integrated movement about or along each of a plurality of axes.

Communication interface 208 enables the transfer of power and data (e.g., the touch-input detected by sensing circuitry 210) between the internal electronics module 204 and the removable electronics module 206. In some implementations, communication interface 208 may be implemented as a connector that includes a connector plug and a connector receptacle. The connector plug may be implemented at the removable electronics module 206 and is configured to connect to the connector receptacle, which may be implemented at the interactive object 104.

In system 200, the removable electronics module 206 includes a microprocessor 212, power source 214, and network interface 216. Power source 214 may be coupled, via communication interface 208, to sensing circuitry 210 to provide power to sensing circuitry 210 to enable the detection of touch-input, and may be implemented as a small battery. When touch-input is detected by sensing circuitry 210 of the internal electronics module 204, data representative of the touch-input may be communicated, via communication interface 162, to microprocessor 152 of the removable electronics module 206. Microprocessor 212 may then analyze the touch-input data to generate one or more control signals, which may then be communicated to a computing device 106 (e.g., a smart phone, server, cloud computing infrastructure, etc.) via the network interface 216 to cause the computing device to initiate a particular functionality. Generally, network interfaces 216 are configured to communicate data, such as touch data, over wired, wireless, or optical networks to computing devices. By way of example and not limitation, network interfaces 156 may communicate data over a local-area-network (LAN), a wireless local-area-network (WLAN), a personal-area-network (PAN) (e.g., Bluetooth™), a wide-area-network (WAN), an intranet, the Internet, a peer-to-peer network, point-to-point network, a mesh network, and the like (e.g., through network 108 of FIG. 1 and FIG. 2).

Object 104 may also include one or more output devices 227 configured to provide a haptic response, a tactical response, an audio response, a visual response, or some combination thereof. Similarly, removable electronics module 206 may include one or more output devices 257 configured to provide a haptic response, tactical response, and audio response, a visual response, or some combination thereof. Output devices 127, 157 may include visual output devices, such as one or more light-emitting diodes (LEDs), audio output devices such as one or more speakers, one or more tactile output devices, and/or one or more haptic output devices. In some examples, the one or more output devices are formed as part of removable electronics module 206, although this is not required. In one example, output device 227 and/or 257 includes one or more LEDs configured to provide different types of output signals. For example, the one or more LEDs can be configured to generate a circular pattern of light, such as by controlling the order and/or timing of individual LED activations. Other lights and techniques may be used to generate visual patterns including circular patterns. In some examples, one or more LEDs may produce different colored light to provide different types of visual indications. Output devices 227 and/or 257 may include a haptic or tactile output device that provides different types of output signals in the form of different vibrations and/or vibration patterns. In yet another example, output device 227 and/or 257 may include a haptic output device such as may tighten or loosen an interactive garment with respect to a user. For example, a clamp, clasp, cuff, pleat, pleat actuator, band (e.g., contraction band), or other device may be used to adjust the fit of a garment on a user (e.g., tighten and/or loosen). In some examples, an interactive textile may be configured to tighten a garment such as by actuating conductive threads within the capacitive touch sensor 102. Gesture manager 219 is capable of interacting with applications 171 at computing devices 106 and capacitive touch sensor 102 effective to aid, in some cases, control of applications 171 through touch-input received by capacitive touch sensor 102. For example, gesture manager 219 can interact with applications 171. In FIG. 2, gesture manager 219 is implemented at removable electronics module 206. It is noted, however, that gesture manager 219 may additionally or alternatively be implemented at internal electronics module 204, a computing device 106 remote from the interactive object, or some combination thereof. Gesture manager 219 may be implemented as a standalone application in some embodiments. In other embodiments, gesture manager 219 may be incorporated with one or more applications at a computing device.

A gesture or other predetermined motion can be determined based on touch data detected by the capacitive touch sensor 102 and/or an inertial measurement unit 258 or other sensor. For example, gesture manager 219 can determine a gesture based on touch data, such as single-finger touch gesture, a double-tap gesture, a two-finger touch gesture, a swipe gesture, and so forth. As another example, gesture manager 219 can determine a gesture based on movement data such as a velocity, acceleration, etc. as can be determined by inertial measurement unit 258.

A functionality associated with a gesture can be determined by gesture manager 219 and/or an application at a computing device. In some examples, it is determined whether the touch data corresponds to a request to perform a particular functionality. For example, gesture manager 219 determines whether touch data corresponds to a user input or gesture that is mapped to a particular functionality, such as initiating a vehicle service, triggering a text message or other notification associated with a vehicle service, answering a phone call, creating a journal entry, and so forth. As described throughout, any type of user input or gesture may be used to trigger the functionality, such as swiping, tapping, or holding capacitive touch sensor 102. In one or more implementations, gesture manager 219 enables application developers or users to configure the types of user input or gestures that can be used to trigger various different types of functionalities. For example, gesture manager 219 can cause a particular functionality to be performed, such as by sending a text message or other communication, answering a phone call, creating a journal entry, increase the volume on a television, turn on lights in the user's house, open the automatic garage door of the user's house, and so forth.

While internal electronics module 204 and removable electronics module 206 are illustrated and described as including specific electronic components, it is to be appreciated that these modules may be configured in a variety of different ways. For example, in some cases, electronic components described as being contained within internal electronics module 204 may be at least partially implemented at the removable electronics module 206, and vice versa. Furthermore, internal electronics module 204 and removable electronics module 206 may include electronic components other that those illustrated in FIG. 2, such as sensors, light sources (e.g., LED's), displays, speakers, and so forth.

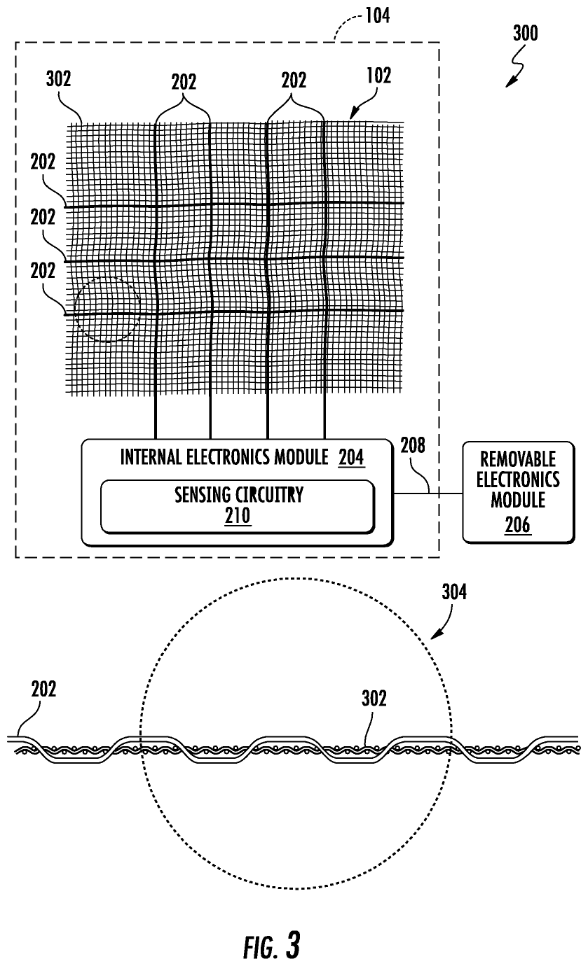

FIG. 3 illustrates an example 300 of interactive object 104 with multiple electronics modules in accordance with one or more implementations. In this example, capacitive touch sensor 102 of the interactive object 104 includes non-conductive threads 302 woven with conductive threads 202 to form capacitive touch sensor 102 (e.g., interactive textile). Non-conductive threads 302 may correspond to any type of non-conductive thread, fiber, or fabric, such as cotton, wool, silk, nylon, polyester, and so forth.

At 304, a zoomed-in view of conductive thread 202 is illustrated. Conductive thread 202 includes a conductive wire or a plurality of conductive filaments that are twisted, braided, or wrapped with a flexible thread. As shown, the conductive thread 202 can be woven with an integrated with the non-conductive threads 302 to form a fabric or a textile. Although a conductive thread and textile is illustrated, it will be appreciated that other conductive lines and substrates may be used, such as flexible metal lines formed on a plastic substrate.

In one or more implementations, conductive thread 202 includes a thin copper wire. It is to be noted, however, that the conductive thread 202 may also be implemented using other materials, such as silver, gold, or other materials coated with a conductive polymer. The conductive thread 202 may include an outer cover layer formed by braiding together non-conductive threads. The non-conductive threads may be implemented as any type of flexible thread or fiber, such as cotton, wool, silk, nylon, polyester, and so forth.

Capacitive touch sensor 102 can be formed cheaply and efficiently, using any conventional weaving process (e.g., jacquard weaving or 3D-weaving), which involves interlacing a set of longer threads (called the warp) with a set of crossing threads (called the weft). Weaving may be implemented on a frame or machine known as a loom, of which there are a number of types. Thus, a loom can weave non-conductive threads 302 with conductive threads 202 to create capacitive touch sensor 102.

The conductive threads 202 can be woven into the capacitive touch sensor 102 in any suitable pattern or array. In one embodiment, for instance, the conductive threads 202 may form a single series of parallel threads. For instance, in one embodiment, the capacitive touch sensor may comprise a single plurality of parallel conductive threads conveniently located on the interactive object, such as on the sleeve of a jacket.

In an alternative embodiment, the conductive threads 202 may form a grid as shown in FIG. 3.

In example 300, conductive thread 202 is woven into capacitive touch sensor 102 to form a grid that includes a set of substantially parallel conductive threads 202 and a second set of substantially parallel conductive threads 202 that crosses the first set of conductive threads to form the grid. In this example, the first set of conductive threads 202 are oriented horizontally and the second set of conductive threads 202 are oriented vertically, such that the first set of conductive threads 202 are positioned substantially orthogonal to the second set of conductive threads 202. It is to be appreciated, however, that conductive threads 202 may be oriented such that crossing conductive threads 202 are not orthogonal to each other. For example, in some cases crossing conductive threads 202 may form a diamond-shaped grid. While conductive threads 202 are illustrated as being spaced out from each other in FIG. 3, it is to be noted that conductive threads 202 may be weaved very closely together. For example, in some cases two or three conductive threads may be weaved closely together in each direction. Further, in some cases the conductive threads may be oriented as parallel sensing lines that do not cross or intersect with each other.

In example 300, sensing circuitry 210 is shown as being integrated within object 104, and is directly connected to conductive threads 202. During operation, sensing circuitry 210 can determine positions of touch-input on the grid of conductive thread 202 using self-capacitance sensing or projective capacitive sensing.

For example, when configured as a self-capacitance sensor, sensing circuitry 210 charges crossing conductive threads 202 (e.g., horizontal and vertical conductive threads) by applying a control signal (e.g., a sine signal) to each conductive thread 202. When an object, such as the user's finger, touches the grid of conductive thread 202, the conductive threads 202 that are touched are grounded, which changes the capacitance (e.g., increases or decreases the capacitance) on the touched conductive threads 202.

Sensing circuitry 210 uses the change in capacitance to identify the presence of the object. To do so, sensing circuitry 210 detects a position of the touch-input by detecting which horizontal conductive thread 202 is touched, and which vertical conductive thread 202 is touched by detecting changes in capacitance of each respective conductive thread 202. Sensing circuitry 210 uses the intersection of the crossing conductive threads 202 that are touched to determine the position of the touch-input on the grid of conductive threads 202. For example, sensing circuitry 210 can determine touch data by determining the position of each touch as X,Y coordinates on the grid of conductive thread 202.

When implemented as a self-capacitance sensor, “ghosting” may occur when multi-touch-input is received. Consider, for example, that a user touches the grid of conductive thread 202 with two fingers. When this occurs, sensing circuitry 210 determines X and Y coordinates for each of the two touches. However, sensing circuitry 210 may be unable to determine how to match each X coordinate to its corresponding Y coordinate. For example, if a first touch has the coordinates X1, Y1 and a second touch has the coordinates X4,Y4, sensing circuitry 210 may also detect “ghost” coordinates X1, Y4 and X4,Y1.

In one or more implementations, sensing circuitry 210 is configured to detect “areas” of touch-input corresponding to two or more touch-input points on the grid of conductive thread 202. Conductive threads 202 may be weaved closely together such that when an object touches the grid of conductive thread 202, the capacitance will be changed for multiple horizontal conductive threads 202 and/or multiple vertical conductive threads 202. For example, a single touch with a single finger may generate the coordinates X1,Y1 and X2,Y1. Thus, sensing circuitry 210 may be configured to detect touch-input if the capacitance is changed for multiple horizontal conductive threads 202 and/or multiple vertical conductive threads 202. Note that this removes the effect of ghosting because sensing circuitry 210 will not detect touch-input if two single-point touches are detected which are spaced apart.

Alternately, when implemented as a projective capacitance sensor, sensing circuitry 210 charges a single set of conductive threads 202 (e.g., horizontal conductive threads 202) by applying a control signal (e.g., a sine signal) to the single set of conductive threads 202. Then, sensing circuitry 210 senses changes in capacitance in the other set of conductive threads 202 (e.g., vertical conductive threads 202).

In this implementation, vertical conductive threads 202 are not charged and thus act as a virtual ground. However, when horizontal conductive threads 202 are charged, the horizontal conductive threads capacitively couple to vertical conductive threads 202. Thus, when an object, such as the user's finger, touches the grid of conductive thread 202, the capacitance changes on the vertical conductive threads (e.g., increases or decreases). Sensing circuitry 210 uses the change in capacitance on vertical conductive threads 202 to identify the presence of the object. To do so, sensing circuitry 210 detects a position of the touch-input by scanning vertical conductive threads 202 to detect changes in capacitance. Sensing circuitry 210 determines the position of the touch-input as the intersection point between the vertical conductive thread 202 with the changed capacitance, and the horizontal conductive thread 202 on which the control signal was transmitted. For example, sensing circuitry 210 can determine touch data by determining the position of each touch as X,Y coordinates on the grid of conductive thread 202.

Whether implemented as a self-capacitance sensor or a projective capacitance sensor, the conductive thread 202 and sensing circuitry 210 is configured to communicate the touch data that is representative of the detected touch-input to removable electronics module 206, which is removably coupled to interactive object 104 via communication interface 208. The microprocessor 212 may then cause communication of the touch data, via network interface 216, to computing device 106 to enable the device to determine gestures based on the touch data, which can be used to control object 104, computing device 106, or applications implemented at computing device 106. In some implementations, a gesture may be determined by the internal electronics module and/or the removable electronics module and data indicative of the gesture can be communicated to a computing device 106 to control object 104, computing device 106, or applications implemented at computing device 106.

The computing device 106 can be implemented to recognize a variety of different types of gestures, such as touches, taps, swipes, holds, and covers made to capacitive touch sensor 102. To recognize the various different types of gestures, the computing device can be configured to determine a duration of the touch, swipe, or hold (e.g., one second or two seconds), a number of the touches, swipes, or holds (e.g., a single tap, a double tap, or a triple tap), a number of fingers of the touch, swipe, or hold (e.g., a one finger-touch or swipe, a two-finger touch or swipe, or a three-finger touch or swipe), a frequency of the touch, and a dynamic direction of a touch or swipe (e.g., up, down, left, right). With regards to holds, the computing device 106 can also determine an area of the grid of conductive thread 202 that is being held (e.g., top, bottom, left, right, or top and bottom. Thus, the computing device 106 can recognize a variety of different types of holds, such as a cover, a cover and hold, a five finger hold, a five finger cover and hold, a three finger pinch and hold, and so forth.

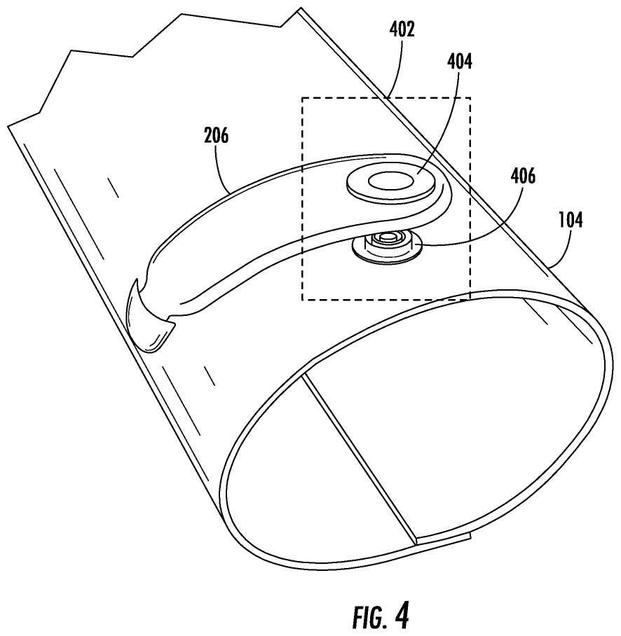

In one or more implementations, communication interface 208 is implemented as a connector that is configured to connect removable electronics module 206 to internal electronics module 204 of interactive object 104. Consider, for example, FIG. 4 which illustrates an example 400 of a connector for connecting a removable communications module to an interactive object in accordance with one or more implementations. In example 400, interactive object 104 is illustrated as a jacket.

As described above, interactive object 104 includes an internal electronics module 204 which include various types of electronics, such as sensing circuitry 210, sensors (e.g., capacitive touch sensors woven into the garment, microphones, or accelerometers), output devices (e.g., LEDs, speakers, or micro-displays), electrical circuitry, and so forth.

Removable electronics module 206 includes various electronics that are configured to connect and/or interface with the electronics of internal electronics module 204. Generally, the electronics contained within removable electronics module 206 are different than those contained within internal electronics module 204, and may include electronics such as microprocessor 212, power source 214 (e.g., a battery), network interface 216 (e.g., Bluetooth or WiFi), sensors (e.g., accelerometers, heart rate monitors, or pedometers), output devices (e.g., speakers, LEDs), and so forth.

In some examples, removable electronics module 206 is implemented as a strap or tag that contains the various electronics. The strap or tag, for example, can be formed from a material such as rubber, nylon, or any other type of fabric. Notably, however, removable electronics module 206 may take any type of form. For example, rather than being a strap, removable electronics module 206 could resemble a circular or square piece of material (e.g., rubber or nylon).

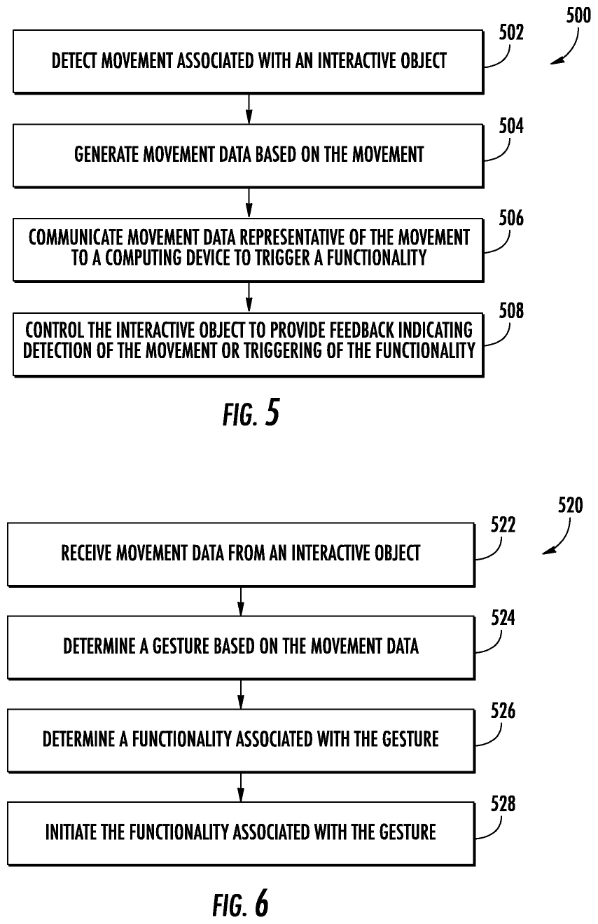

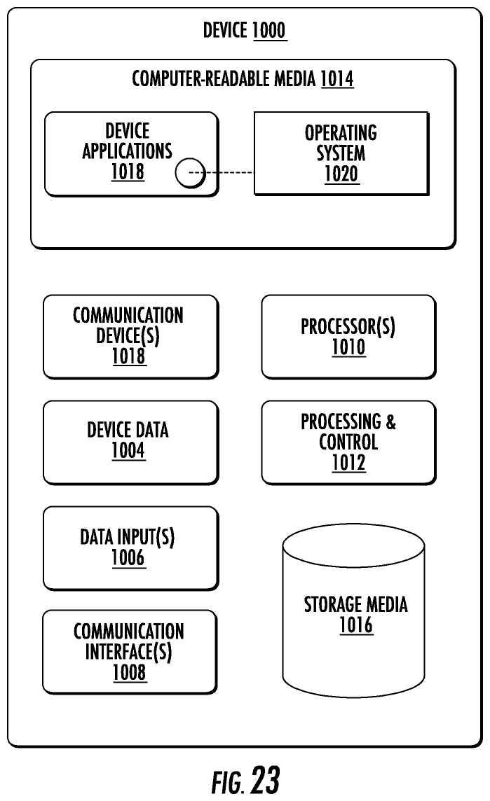

FIGS. 5 and 6 illustrate an example process 500 (FIG. 5) of generating touch data using an interactive object, and an example process 520 (FIG. 6) of determining gestures usable to control a computing device or applications at the computing device based on touch data received from an interactive object. These methods and other methods herein are shown as sets of blocks that specify operations performed but are not necessarily limited to the order or combinations shown for performing the operations by the respective blocks. One or more portions of process 500, and the other processes described, can be implemented by one or more computing devices such as, for example, one or more computing devices of a computing environment 100 as illustrated in FIG. 1, computing environment 200 as illustrated in FIG. 2, or a computing environment 1000 as illustrated in FIG. 23. While in portions of the following discussion reference may be made to environment 100 of FIG. 1 and system 200 of FIG. 2 or system 2000 of FIG. 23, reference to which is made for example only. The techniques are not limited to performance by one entity or multiple entities operating on one device. One or more portions of these processes can be implemented as an algorithm on the hardware components of the devices described herein.

At 502, process 500 may include detecting movement associated with a user of the interactive object. For example, block 502 may include detecting touch-input to a grid of conductive thread woven into an interactive textile. For example, sensing circuitry 210 (FIG. 2) can detect touch-input to the grid of conductive thread 202 woven into capacitive touch sensor 102 (FIG. 1) when an object, such as a user's finger, touches capacitive touch sensor 102. Touch input provided to the grid of conductive thread 202 is one example of movement associated with the interactive object that can be detected by one or more sensors of the interactive object. As another example, movement can be detected by one or more inertial measurement units of the interactive object indicating a velocity and/or acceleration of the interactive object, for example.

At 504, movement data such as touch data is generated based on the touch-input. For example, sensing circuitry 210 can generate touch data based on the touch-input. The touch data may include a position of the touch-input on the grid of conductive thread 202. In another example, the movement data can include inertial measurement unit data based on movement of the interactive object as can be detected by an inertial measurement unit.

As described throughout, the grid of conductive thread 202 may include horizontal conductive threads 202 and vertical conductive threads 202 positioned substantially orthogonal to the horizontal conductive threads. To detect the position of the touch-input, sensing circuitry 210 can use self-capacitance sensing or projective capacitance sensing.

At 506, movement data is communicated to a computing device to control the computing device or one or more applications at the computing device. For example, communication interface 208 at object 104 can communicate the touch data generated by sensing circuitry 210 to gesture manager 219 implemented at removable electronics module 206. Gesture manager 219 and a computing device 106 may be implemented at object 104, in which case interface 208 may communicate the touch data to gesture manager 219 via a wired connection. Additionally or alternately, gesture manager 219 and computing device 106 may be implemented remote from object 104, in which case network interface 216 may communicate the touch data to gesture manager 219 via network 108. It is noted that the movement data such as touch data may include various types of data. For example, the movement data may include raw sensor data in some examples. In other examples, the movement data may include data indicative of a gesture or intermediate representation of the sensor data as has been determined by the object (e.g., by microprocessor 212 and/or microprocessor 228).

Optionally, the interactive garment can be controlled to provide feedback indicating detection of the touch-input or triggering of the functionality. For example, sensing circuitry 210 can control one or more output devices 227 and/or 257 to provide feedback indicating the touch-input was detected, such as by controlling a light source to blink or controlling a vibration component to vibrate. As another example, sensing circuitry 210 can control one or more output devices 227 and/or 257 to provide feedback indicating that a particular function has been triggered. As another example, microprocessor 212 and/or microprocessor 228 can control one or more output devices 227 and/or 257 to provide feedback indicating that a particular function has been triggered. For instance, an LED can be integrated into the sleeve of an interactive garment, and is controlled to output light (e.g., by blinking) in response to detecting the touch-input or in response to confirming that the touch-input caused the particular functionality to be triggered. An LED can be integrated into an external module in some cases. Other output devices can be integrated into an interactive object or external module.

FIG. 6 illustrates an example process 520 of determining gestures usable to control a computing device or applications at the computing device based on movement data received from an interactive object. Process 520 includes initiating a functionality that is triggered by user interaction with an interactive garment. The computing device may be local to the interactive object, such as incorporated within a garment or object, or may be remote to the interactive object, such as a smartphone or a remote computing device such as a server.

At 522, movement data such as touch data or inertial measurement unit data is received from an interactive object. For example, a network interface at a computing device 106 can receive touch data from network interface 216 at interactive object 104 that is communicated to gesture manager 219 in one example.

At 524, a gesture or other predetermined motion is determined based on the touch data or other movement data. For example, gesture manager 219 determines a gesture based on the touch data, such as single-finger touch gesture 506, a double-tap gesture 516, a two-finger touch gesture 526, a swipe gesture 538, and so forth. In another example, gesture manager 219 determines gesture based on inertial measurement unit data, such as a predetermined motion detected by movement of the user an interactive object.

At 526, a functionality associated with the gesture is determined. In some examples, it is determined whether the movement data corresponds to a request to perform a particular functionality. For example, gesture manager 219 determines whether touch data corresponds to a user input or gesture that is mapped to a particular functionality, such as triggering an output response such as an audible output associated with a vehicle service, triggering a text message associated with the vehicle service, answering a phone call, creating a journal entry, and so forth. As described throughout, any type of user input or gesture may be used to trigger the functionality, such as swiping, tapping, or holding capacitive touch sensor 102. In one or more implementations, gesture manager 219 enables application developers or users to configure the types of user input or gestures that can be used to trigger various different types of functionalities.

At 528, the functionality is initiated. For example, gesture manager 219 causes a particular functionality to be performed, such as by obtaining data associated with a vehicle service and initiating an output response that provides an indication of the data, answering a phone call, creating a journal entry, increase the volume on a television, turn on lights in the user's house, open the automatic garage door of the user's house, and so forth.

According to example embodiments of the present disclosure, vehicle-related notifications and gestures are provided that can facilitate ridesharing and other vehicle-related services. By way of example, an interactive textile, integrated into an interactive object such as a wearable garment for example, may be provided to facilitate ridesharing efficiencies by providing convenient context-sensitive signaling to the user regarding the status of a requested ride. In some instances, this may allow a phone or other computing device to remain in a user's pocket, purse, etc., or otherwise out of sight, by eliminating the need for the user to look at their smartphone after they have ordered the ride. It is noted that integration with a smartphone or other computing device remote from the garment is not required. For example, the interactive textile may include an integrated computing device that can perform one or more of the functions described herein.

More particularly, in some examples, different notifications or notification types may be used in accordance with vehicle-related services such as ridesharing. For example, a first type of optical, tactile, audio, haptic, or other signal (such as a cuff-mounted LED lightup) can be emitted when a driver or vehicle comes within a predefined radius (or other general closeness metric) to a location. The location may be a predefined pickup location, the location of the user, the location of the interactive textile, or the location of a computing device external to the interactive textile. A second type of optical or tactile signal (such as a vibration of a cuff-mounted buzzer) can be emitted when the driver has arrived at the pickup location.

According to some embodiments, a variety of additional systems and methods are provided. For example, actuated fabric tightening/loosening can be used as one or more of the tactile signals. In one embodiment, an arm or other portion of the garment can provide a mild squeeze signal to the user's arm when the driver arrives, in addition to (or as an alternative to) the vibrating cuff button. As another example, there can be a so-called “analog” relationship between the actuated arm squeezing and the location of the driver, wherein the fabric tightening/squeezing increases gradually according to the declining distance between the driver and the pickup point.

Finally, in some embodiments, there can further be provided predefined and/or user-definable garment-actuated communication back to the driver according to signals given from the user to their garment. By way of example, providing an upward cuff swipe can trigger a text message to the driver that the user needs another 5 minutes to walk to the pickup location, whereas a sideways cuff swipe can trigger a text message that says the user is ready at the pickup location. By way of further example, using an appropriately-sensored garment capable of monitoring arm position relative to the body, the user can raise their arm and wave it over their head to trigger a text message to the driver that says “I can see you,” for example.

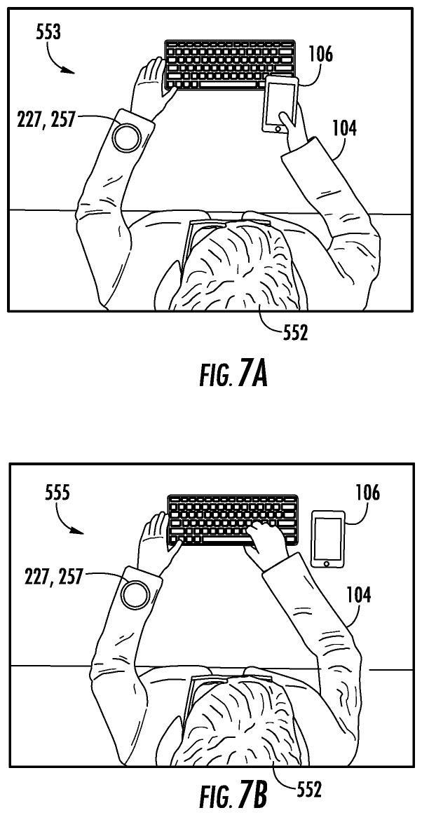

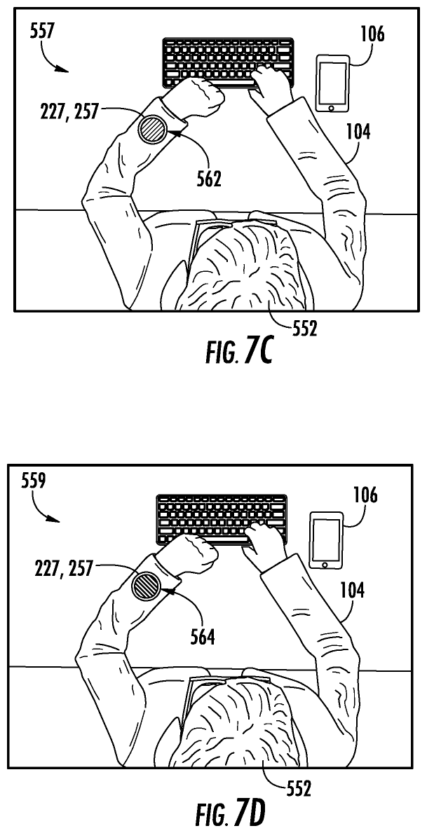

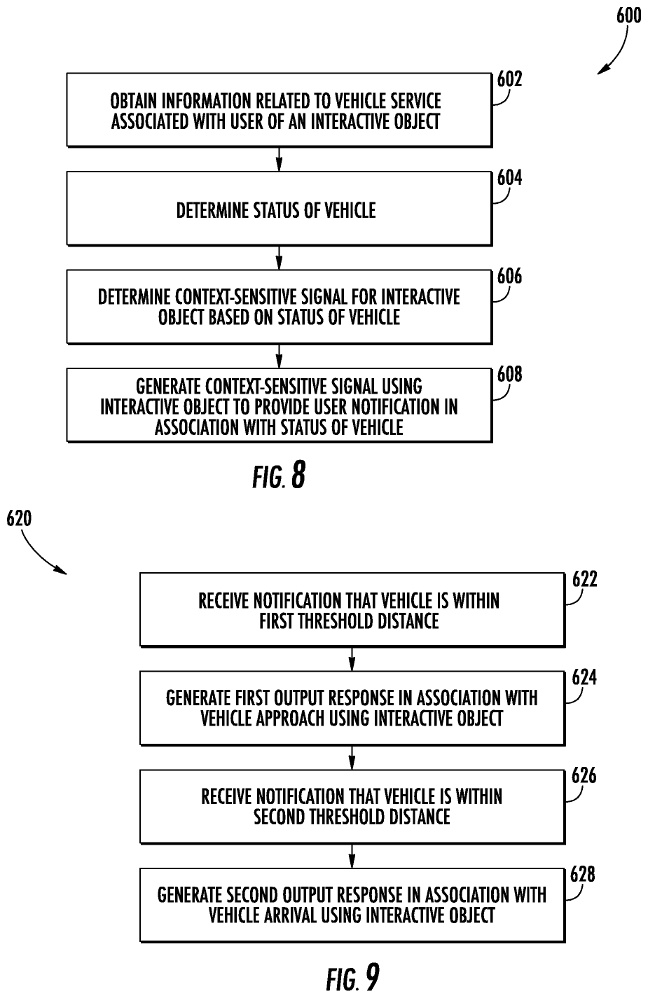

FIGS. 7A-7D depict an overhead view of a user 552 interacting with an example interactive object 104 and an example local computing device 106 in accordance with example embodiments of the present disclosure. At 553 in FIG. 7A, user 552 interfaces with local computing device 106 to call a ride using a ridesharing service via an application on the computing device 106. For example, a service entity can provide a ridesharing service that connects vehicles and/or drivers with users. A user may utilize an application 171 on a computing device to request a vehicle service which can include a vehicle picking up the user and transporting the user to a designated location. In some examples, the user may provide an input via the interactive object 104 in order to initiate a request for a vehicle service. For example, the user may provide a touch input indicative of the gesture to a capacitive touch sensor of the interactive object, and/or may perform a movement that can be detected by an inertial measurement unit of the interactive object. In some examples, a gesture manager at the interactive object and/or the computing device 106 may detect the gesture and provide an indication of the gesture to the application associated with the ridesharing service.

At 555 in FIG. 7B, the user 552 is depicted going back to work or another activity while the requested ride or vehicle is on the way. As illustrated, the user's local computing device 106 placed down and away from the users of the user can focus their attention on the task at hand.

At 557 in FIG. 7C, the user 552 is depicted receiving a first notification 562 via an output device 127, 157 of the interactive object. The first notification may be provided via an output device 127 of the internal electronics module 204, an output device 257 of the electronics module 206, and/or an output device otherwise integrated into interactive object 104. The notification is related to the request for a vehicle service via the interactive object 104. For example, the first notification 562 can indicate that the vehicle associated with the vehicle service ordered by the user is within a predetermined distance or radius of the user and/or interactive object. The notification can be an output response provided by one or more output devices (e.g., 127 or 157) of the interactive object 104. More particularly, the first notification 562 can include a visual output response provided by one or more visual output devices of the interactive object 104. The first notification 504 can include a first colored output and/or a first light pattern in some examples. For instance, interactive object 104 can include a removable electronics module including one or more visual output devices capable of generating a visual output response. In another example, interactive object 104 can include an internal electronics module having one or more visual output devices. In some examples, the interactive object output device such as a snap tag can communicate that the vehicle is nearby. In one example, the snap tag or other output device includes a visual output device that provides circle light when the car is nearby and until the car arrives. In some examples, the snap tag can buzz or vibrate when the light begins to circle. One or more haptic devices and/or tactile devices can be used. In various examples, the second output response can include a visual output response, audible output response, and/or a haptic output response.

At 559 in FIG. 7D, the user 552 depicted receiving a second notification 564. For example, the second notification 564 can indicate that the vehicle is within a second predetermined distance or radius of the user and/or interactive object. The second distance can be smaller than the first distance such that the user receives a different notification when the vehicle is closer to the user. In some examples, the second notification 564 can indicate that the vehicle has reached a designated location associated with a vehicle service. In some examples, the second notification 564 can include a different notification pattern provided by the output device of the interactive object 104. More particularly, the second notification 564 can include a second colored output response and/or light pattern in some examples. In this example, the interactive textile including the output device may blink using a visual indicator and/or buzz using a haptic indicator to provide the second notification. In various examples, the second output response can include a visual output response, audible output response, and/or a haptic output response.

FIG. 8 is a flowchart describing an example process 600 in accordance with example embodiments of the present disclosure. Process 600 can be used to provide one or more context-sensitive signals using an interactive object. The context sensitive signals provide user notifications in association with the vehicle service. In example embodiments, process 600 may be performed by one or more computing devices of an interactive object and/or one or more computing devices communicatively coupled to the interactive object to generate notifications associated with a vehicle service.

At 602, process 600 can include obtaining data including information related to a requested ride (e.g., vehicle service) associated with an interactive object (e.g., interactive garment). The data may be received directly at the interactive object or by a remote computing device such as a smart phone or other computing device associated with the interactive garment. The data associated with the vehicle service may include, but is not limited to, data indicative of one or more vehicles associated with the vehicle service. The one or more vehicles may be designated to provide the vehicle service to the user. By way of example, the data associated with the vehicle service may include data indicative of the vehicle color, vehicle model, license plate number, and/or other information associated with the vehicle.

At 604, process 600 can include determining the status of the vehicle that is providing the vehicle service requested by the user. At 604, process 600 can include determining the status of the requested ride based on the data including the information obtained for the requested ride. For example, a distance between the vehicle providing the vehicle service and the user and/or the interactive object can be determined. In one example, a computing device can determine a distance between a computing device associated with the vehicle and a computing device associated with the user. Global positioning system signals and/or other location information may be used. In some examples, a local computing device such as a user smart phone can receive data associated with the status of the vehicle that is providing a vehicle service associated with the user of the interactive object.

At 606, process 600 can include determining a context sensitive signal for the interactive garment based on the status of the requested ride. For example, the computing system may determine a first signal type in response to a first status such as in response to a vehicle being on its way or being within a first threshold distance of the user or pickup location, for example. A different signal type may be determined in response to a different status such as the vehicle having arrived at a pickup location. In some examples, a context-sensitive signal may include an output signal that is indicative of the status of the vehicle. The output signal can be based at least in part on the data associated with status of the vehicle. The context-sensitive signal can be determined by the interactive object and/or a remote computing device such as the user's smart phone.

At 608, process 600 can include generating the context sensitive signal using the interactive garment to provide a user notification in association with the status of the requested ride. The interactive object may generate one or more output responses that are indicative of the status of the vehicle in response to the one or more context-sensitive signals. For example, a visual output device or haptic output device of the interactive object may generate one or more output responses in response to the one or more context sensitive signals. The one or more output responses can be indicative of the status of the vehicle. In some examples, the interactive object can generate and/or provide one or more output signals for one or more output devices of the interactive object at 608. For example, the one or more output signals can be based at least in part on the data associated with status of the vehicle. By way of example, the computing device can determine that an output signal is to be provided to a visual output device to generate a first visual output based on a first status (e.g., within a first predetermined distance of the interactive object). The computing device can determine that an output signal is to be provided to the visual output device to generate a second visual output based on a second status (e.g., within a second predetermined distance of the interactive object). Other output responses such as haptic responses, textual responses, and/or audible responses can be used. Process 600 can include generating the context sensitive signal using the interactive garment to provide a user notification as an output response in association with the status of the requested ride.

FIG. 9 is a flowchart describing a process 620 in accordance with example embodiments of the present disclosure. Process 620 may be used to generate context-sensitive signals and different output responses at an interactive object based on a status associated with a vehicle service. At 622, process 620 can include receiving a notification or other information indicating that a vehicle or ride is within a first threshold distance of a user. The notification may indicate that the vehicle is within the threshold distance of the user, the interactive garment, a remote computing device, a predefined pickup location, or other location. Data indicative of the vehicle being within a first threshold distance of the user can be received by the interactive object or by a computing device such as a smartphone communicatively coupled to the interactive object. By way of example, a user's smart phone may receive data associated with the vehicle's location and provide a control signal to the interactive object to initiate a first output response at the interactive object. The user's smart phone can determine the distance between the vehicle and the user (e.g., using the interactive object or the smart phone location). In another example, data associated with the vehicle may be received directly by the interactive object. In some examples, the interactive object can generate one or more output signals for one or more output devices of the interactive object based on the data indicating that the vehicle is within the first threshold distance.

At 624, process 620 can include generating a first output response using the interactive garment to indicate a vehicle approach or to otherwise indicate that the vehicle is within the first threshold distance. For example, the first output response can be generated in response to a first notification which may include a first signal type. More particularly, the first signal type may be indicative of a first visual output such as a first light pattern or light color. As another example, the first signal type may be indicative of a first audio output or first haptic output.

At 626, process 620 can include receiving a notification or other information indicating that a vehicle or ride is within a second threshold distance of the user. The second threshold distance can be less than the first threshold distance. The notification may indicate that the vehicle is within the second threshold distance of the user, the interactive garment, a remote computing device, a predefined pickup location, or other location. Similar to the data indicative of the vehicle being within the first threshold distance, data indicative of the vehicle being within the second threshold distance can be received by the interactive object or by a computing device such as a smartphone communicatively coupled to the interactive object.

At 628, process 620 can include generating a second output response using the interactive garment to indicate a vehicle arrival or to otherwise indicate that the vehicle is within the second threshold distance. For example, the second output response can be generated in response to a second notification which may include a second signal type. More particularly, the second signal type may be indicative of a second visual output such as a second light pattern or light color. As another example, the second signal type may be indicative of a second audio output or second haptic output. As yet another example, an arm portion of the interactive garment can provide a mild squeeze to signal when the vehicle arrives.

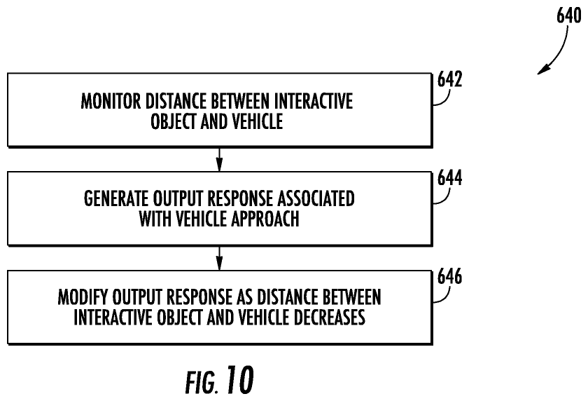

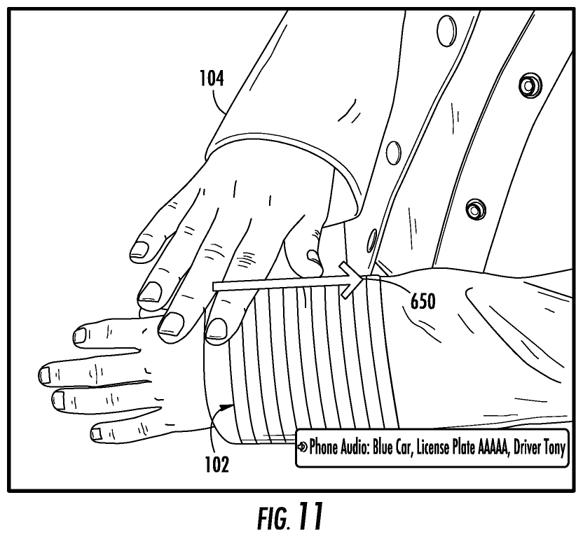

FIG. 10 is a flowchart describing a process 640 in accordance with example embodiments of the present disclosure. At 642, Process 640 can include monitoring a distance between an interactive object such as an interactive garment and a vehicle associated with the ridesharing service. This process may include monitoring a distance relative to the interactive object itself, or monitoring a distance relative to a computing device associated with the interactive object.

At 642, process 640 can include generating an output response associated with a vehicle approach using the interactive object. The output response may include a signal or other output such as a visual indication, audio indication, or haptic indication associated with the vehicle approach. For instance, the output response may be a first visual output such as a circle light pattern produced by an output device. In one example, the output response may include a tactile response such as by providing a mild squeeze to a user using the interactive garment. For instance an actuated fabric tightening or loosening may be used to indicate a vehicle approach.

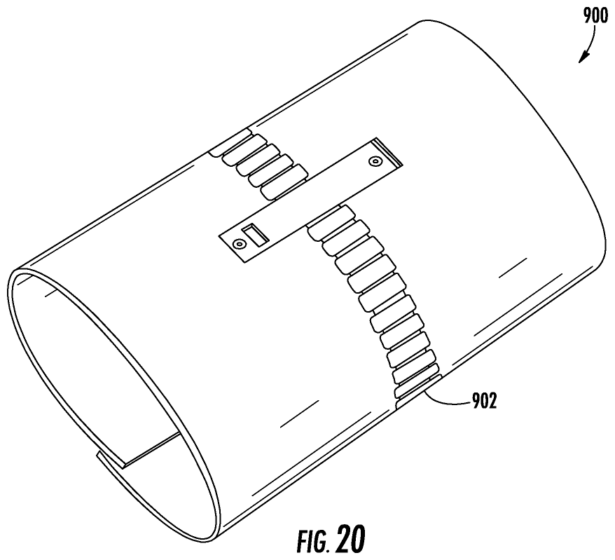

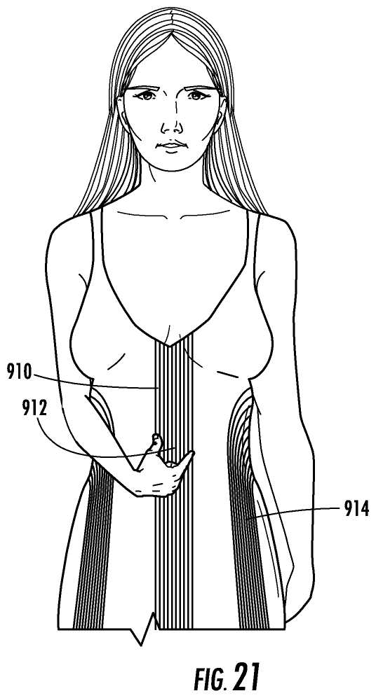

At 646, process 640 can include modifying the output response as the distance between the interactive garment and the vehicle decreases. A tactile response is modified in one example as the vehicle approaches. For example, the garment may become tighter or provide a stronger squeeze as the location of the vehicle becomes closer to the interactive garment. For instance, there may be an analog relationship between the actuated arm squeezing and the location of the driver. The fabric tightening/squeezing can increase gradually according to the declining distance between the driver in the pickup point or the interactive garment. More details regarding haptic and tactile output devices configured for fabric tightening/squeezing are described hereinafter with respect to FIGS. 20-22.

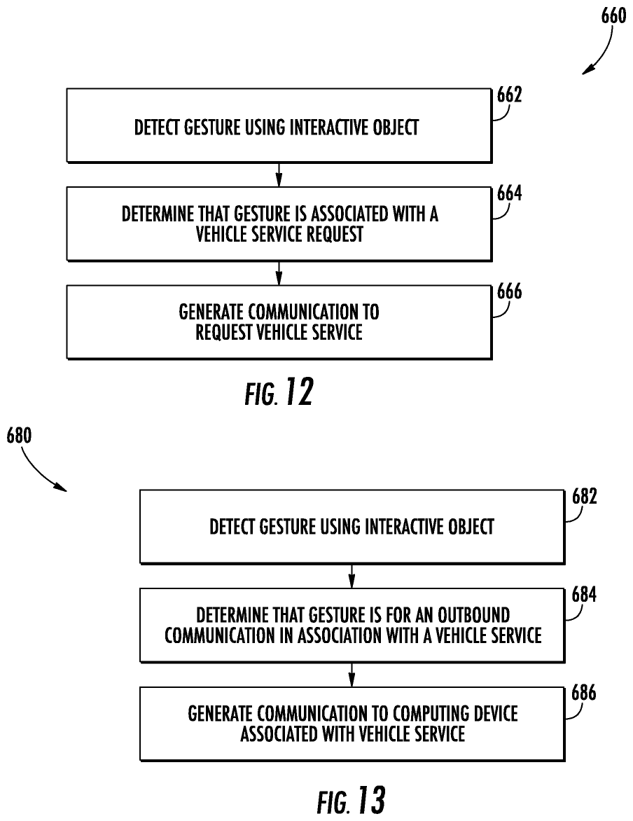

FIG. 11 is a perspective view of an example of a user interacting with an interactive object 104 in accordance with example embodiments of the present disclosure. In this example, a user can perform a gesture by brushing in on the cuff (as depicted by arrow 650) of the interactive object 104 cuff where the capacitive touch sensor 102 is placed in order to receive a notification related to the rideshare service. More particularly, while the output device is providing a visual indication including a notification pattern that a ride is nearby or has arrived, the user is able to brush in on the interactive object cuff to have the computing device read out using an audio output of the notification received from the ride sharing service. A specific example is shown where a phone audio output response states your ridesharing service is provided by a Blue Car, with License Plate AAAAA, and the driver is Tony.

FIG. 12 is a flowchart describing a process 660 in accordance with example embodiments of the present disclosure. At 652, process 660 can include detecting a gesture using an interactive garment or other object. The gesture may be detected directly at the interactive garment using a computing device integrated with the interactive garment, or may be detected by a remote computing device such as a smart phone or remote server. For example, touch data may be provided from the interactive garment to a computing device (local or remote to the interactive object) which determines that a gesture has been performed. In another example, movement data from an inertial measurement unit may be provided from the interactive object to a computing device (local or remote to the interactive object) which determines a gesture has been performed.

At 664, process 660 can include determining that the gesture is associated with a vehicle service request. The vehicle service request may be associated with a ridesharing service. The ridesharing service may be associated with one or more applications executed by a computing device such as a smart phone in communication with the interactive garment.

At 666, process 660 can include generating a communication to request a ride using the ridesharing service. The communication may include a call or other interaction with an application associated with the ridesharing service on the computing device. In some examples, the interactive object may send a communication directly to a vehicle and/or computing device of the driver associated with the vehicle service. In other examples, a communication may be sent from a remote computing device 106 to the vehicle and/or computing device of the driver.

FIG. 13 is a flowchart describing a process 680 in accordance with example embodiments of the present disclosure. At 682, process 680 can include detecting a gesture using an interactive object. At 684, process 680 can include determining that the gesture is for an outbound communication in association with a vehicle service. At 686, process 680 can include generating a communication to a remote computing device associated with the vehicle service.

By way of example, the user may provide a first gesture such as an upward cuff swipe that can trigger a text message to a computing device associated with a driver of the vehicle. The text message can indicate that the user needs a longer time in order to reach a pickup location. A second gesture such as a sideways cuff swipe can be provided to trigger a text message that says that the user is ready at the pickup location. Other types of messages other than text messages may be sent and received. For example, the gestures may trigger communication within an application associated with the ridesharing service. For example, the gesture may utilize an API associated with an application on a user's computing device in order to generate communication to a driver through a cloud-based or other remote service.

As another example, an appropriately-sensored garment capable of monitoring or position relative to a user's body can be used so that the user can raise and/or wave with their hand over their head to provide a gesture to trigger a text message or other communication to the driver that says “I can see you” or another notification.

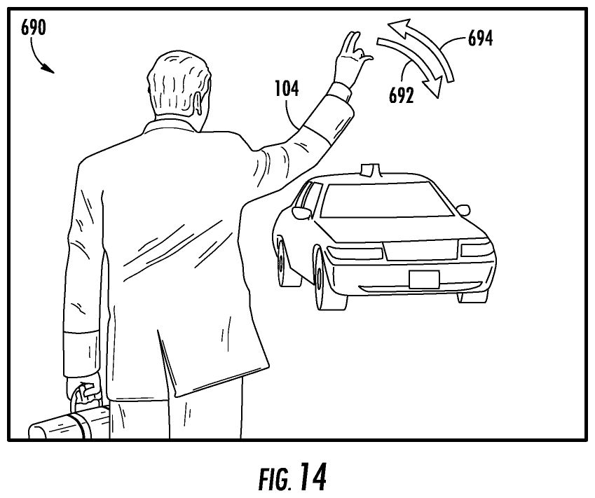

FIG. 14 illustrates a user 552 performing a wave gesture as indicated by arrows 692, 694. The computing device of the interactive object 104 (e.g., the user's coat) may detect the predetermined wave gesture based on sensor data from an inertial measurement unit. Alternately, movement data can be transmitted to a remote computing device such as a user smart phone which can determine that the wave gesture has been performed. In response to detecting the wave gesture the interactive object and/or remote computing device can initiate a communication to a computing device associated with the vehicle and/or driver of the vehicle.

FIG. 15 illustrates an example process 720 of assigning a gesture to a functionality of a computing device in accordance with one or more implementations. At 722, process 720 can include receiving movement data such as touch data at a computing device from an interactive textile woven into an item of clothing worn by the user. In another example, movement data from an inertial measurement unit of an interactive object can be received at the computing device. For example, a network interface at a computing device 106 can receive touch data from network interface 216 at capacitive touch sensor 102 that is woven into an item of clothing worn by a user, such as a jacket, shirt, hat, and so forth.

At 724, process 720 can include analyzing the touch data or other movement data to identify a gesture. For example, gesture manager 219 can analyze the touch data to identify a gesture, such as a touch, tap, swipe, hold, or gesture stroke.

At 726, process 720 can include receiving a user input to assign the gesture to a functionality of the computing device. For example, gesture manager 219 can receive user input at the user interface to assign the gesture created to a functionality of computing device 106.

At 728, process 720 can include assigning the gesture to the functionality of the computing device. For example, gesture manager 219 can assign the functionality selected to the gesture created.

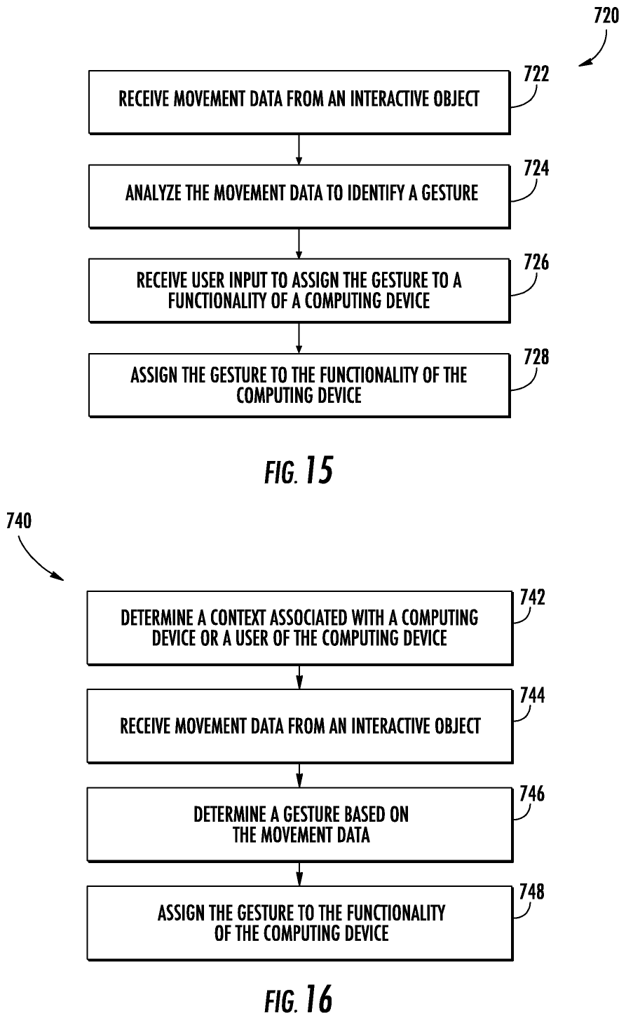

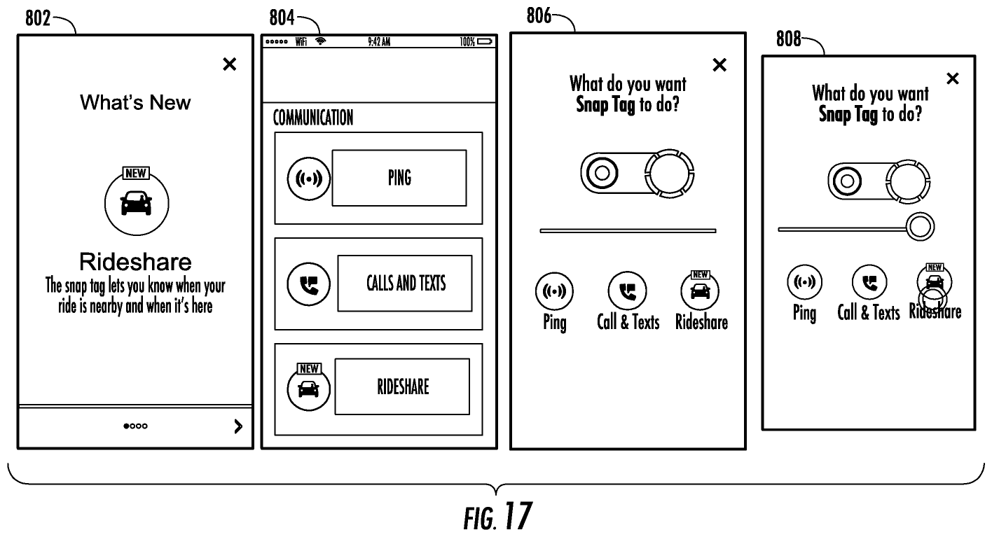

FIG. 16 illustrates an example process 740 of initiating a functionality of a computing device based on a gesture and a context in accordance with one or more implementations. At 742, process 740 can include determining a context associated with a computing device or a user of the computing device. For example, gesture manager 219 can determine a context associated with computing device 106 or a user of computing device 106. In another example, gesture manager 219 can determine a context associated with the interactive object such as a computing device of the interactive object.

At 744, process 740 can include receiving touch data or other movement data at the computing device from an interactive object. For example, touch data can be received at computing device 106 from capacitive touch sensor 102 woven into a clothing item worn by the user, such as jacket, shirt, or hat.

At 746, process 740 can include analyzing the touch data or other movement data to identify a gesture. For example, gesture manager 219 can analyze the touch data to identify a gesture, such as a touch, tap, swipe, hold, stroke, and so forth.

At 748, process 740 can include activating a functionality based on the gesture and the context. For example, gesture manager 219 can activate a functionality based on the gesture identified and the context determined.

The preceding discussion describes methods relating to gestures for interactive textiles. Aspects of these methods may be implemented in hardware (e.g., fixed logic circuitry), firmware, software, manual processing, or any combination thereof. These techniques may be embodied on one or more of the entities shown herein and which may be further divided, combined, and so on. Thus, these figures illustrate some of the many possible systems or apparatuses capable of employing the described techniques. The entities of these figures generally represent software, firmware, hardware, whole devices or networks, or a combination thereof.

FIG. 17 depicts a graphical user interface as may be displayed by a computing device 106 in order to facilitate vehicle-related notifications in accordance with example embodiments of the disclosed technology. Although a particular graphical user interface is described, it will be appreciated that a graphical user interface is not required in all implementations, and the other graphical user interfaces may be used.

A first display or modal of the graphical user interface at 802 may depict information explaining a new ridesharing feature whereby an interactive textile enables notifications of when a ride or vehicle is nearby and when a ride or vehicle has arrived. For example, the display can display text describing that the interactive object's removable electronics module (e.g., snap tag including visual and haptic output devices) lets the user know when a ride is nearby, when a ride has arrived, and/or when it's time to get going. In some examples, a first modal may be displayed to announce the rideshare functionality when a user receives an update with the new abilities. As illustrated, reference to a snap tag may be made in reference to an output device 257 of a removable electronics module 206 of the interactive object, or to the removable electronic module 206 as shown in FIG. 2. In such an example, the snap tag may include a visual output device, an audio output device, and/or tactile (e.g., haptic) output device. In a specific example, the snap tag includes a visual output device including one or more LEDs configured to provide visual output in the form of multicolored light and different patterns, including a circular pattern of light.

A second display or modal of the graphical user interface at 804 can describe various features of the interactive object. The second modal may explain that the ridesharing functionality lives in abilities within the communication of the application. When the application is launched, the ability can be tagged with a new badge. In the graphical user interface, reference may be made to an example of an interactive object, such as a jacket including an interactive textile. The jacket may further include a tag or other removable electronics module providing one or more output devices 257. In some examples, the interactive object is configured to let a user know when a call and/or text has been received so that they can be present and off of their phone or other computing device 106. Additionally, notifications for calls and texts can be provided in the form of light and vibration to notify the user of any incoming calls and texts to their phone or other computing device 106. In addition, a gesture such as brushing the interactive textile on the cuff of the jacket enables a response to the call and/or text. Finally, ridesharing is facilitated through the interactive textile. More particularly, the removable electronics module (e.g., snap tag) enables the user to know when a ride is nearby and when the ride has arrived.

A third display or modal of the graphical user interface at 806 enables a user to configure the snap tag or other output device for particular functionality. The third modal can allow interfacing with the rideshare functionality using an assign to snap tag screen as depicted at 808. A user may drag-and-drop a “ping” icon to the snap tag icon in order to assign a ping functionality to the snap tag. A “calls and texts” icon may be dragged to the snap tag icon to enable a calls and texts functionality. Finally, a “rideshare” icon may be dragged to the snap tag to enable a rideshare functionality. The graphical user interface depicted at 808 illustrates that a user can drag a rideshare icon to the snap tag icon to assign the rideshare functionality to the snap tag.

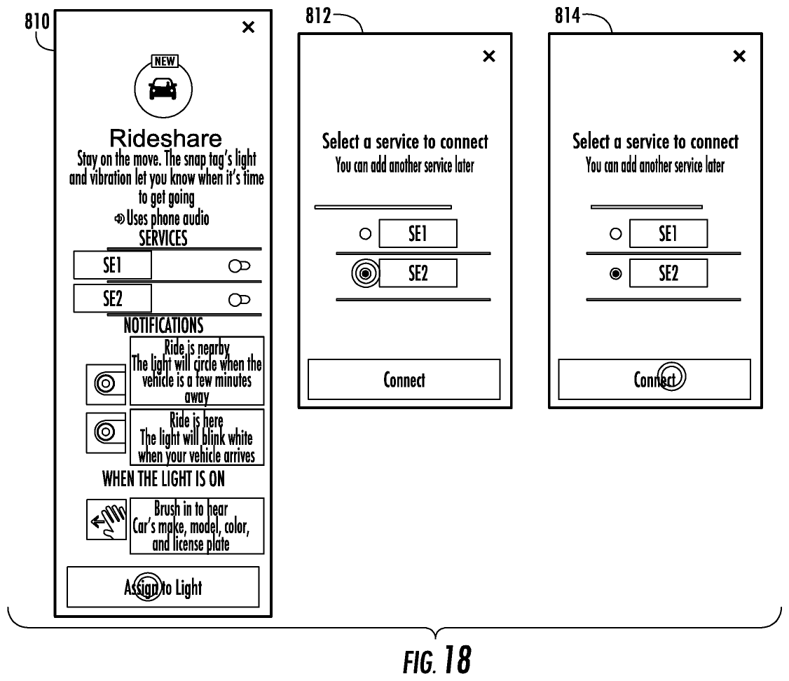

FIG. 18 depicts further examples of the graphical user interface. In response to dragging the rideshare icon to the snap tag icon, a fifth display or modal of the graphical user interface at 810 may be provided as shown. In this example, various rideshare services are available. The user may select one or more of the rideshare services. Notifications associated with the one or more ride services are displayed. For example the display may explain that when a ride is nearby the light on the output device may circle to indicate that the car is a few minutes away. This may comprise a first output signal and/or output response. Other examples of output signals may be used. When the ride has arrived, a notification will be provided in the form of the light blinking white when the vehicle arrives. This may comprise a second different output signal. The user interface can explain that when the light is on the interactive object such as on the output device 257, the user may brush in on an interactive textile to hear a notification associated with the rideshare service. In this particular example, brushing in will result in output device 257 and/or computing device 106 providing an output in the form of audio providing the vehicle's make, model, color, and/or license plate. The user can provide input to the assign to light icon to indicate that they wish to assign the rideshare functionality to the interactive object.

A sixth display or modal of the graphical user interface at 812 allows the user to select between multiple ridesharing services. A seventh display or modal of the graphical user interface at 814 illustrates that the user may provide input to the connect icon after indicating a particular ridesharing service. In response to selecting a rideshare service, the graphical user interface can explain to the user that the interactive object will read out notifications and text messages from the ridesharing service when the ride arrives.

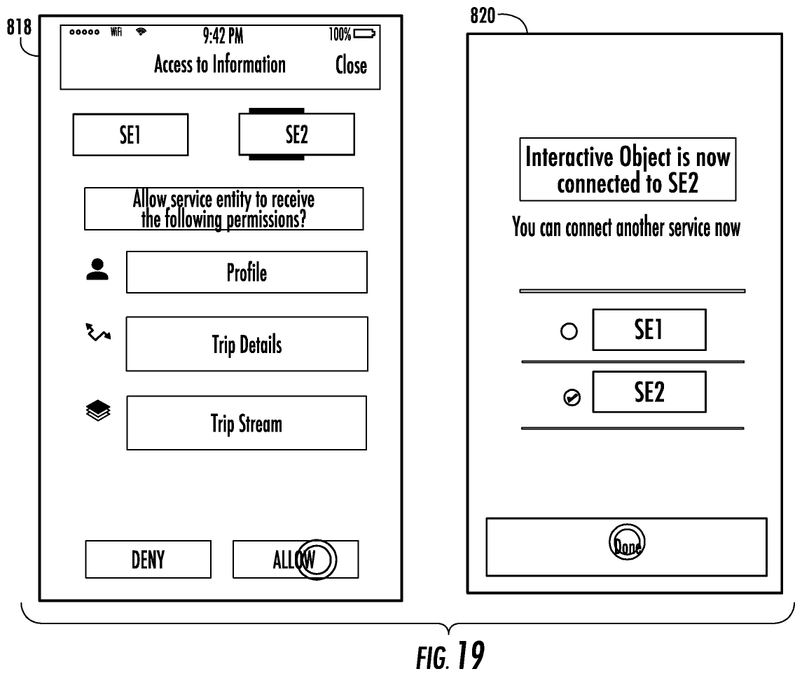

FIG. 19 depicts further examples of the graphical user interface. In this example, an eighth display or modal of the graphical user interface at 818 can be displayed. The graphical user interface can indicate information such as profile information, trip details information, stream information, etc. that may be accessed by the ridesharing service and/or and application associated with the interactive object such as a gesture manager. An icon is provided to receive user input indicating that they allow access to the rideshare service by the interactive object. A ninth display or modal of the graphical user interface at 820 can be displayed indicating that the interactive object is connected to the selected ridesharing service. The user may provide input indicating that they are done setting up the interactive object with the ridesharing service.

In some examples, in response to the user indicating that they allow access, a display is shown allowing the user to assign additional functionality to the snap tag or to reconfigure existing functionality assigned to the snap tag.

In one embodiment, the conductive yarns in conjunction with one or more electronic modules can control flexible haptics without the need for a motor. Garments made according to the present disclosure can include various different haptics devices that can provide compression or relaxation. The garment can include a capacitive touch sensor for receiving user input for controlling the haptics devices. Various interactive garments may include, for instance, compression pants, compression bra. The compression pants, for instance, can include a capacitive touch sensor that is in communication with compression panels. The capacitive touch sensor in conjunction with one or more electronics modules can be used to increase or lower the level of compression placed on the legs of the wearer by the compression panels. Similarly, a compression bra can include a capacitive touch sensor that is in communication with a plurality of compression panels. The compression panels can be controlled by the capacitive touch sensor in order to cycle through different levels of compression. In some examples, the amount of compression may be responsive to one or more output signals generated based on a vehicle related notification.

For example, the conductive yarns may permit the user to control a number of “smart material” actuators; piezoelectric materials, electroactive polymers, and dielectric elastomers all exemplify materials which can provide a haptic response to a touch-input instruction from a user without the need for a motor. For example, electrically activated materials (e.g. those listed above) can be used to induce torsional and/or linear motion responsive to an electrical signal. In one embodiment, multiple segments composed of a piezoelectric composite may be linked together in a ring shape; application of electrical potential across the electrodes of each segment can increase or decrease the diameter of the ring. In another example, electroactive polymers can be used to change or adapt the texture of the surface of an interactive object 104 responsive to an applied electrical field.

For example, one embodiment of a flexible haptic device is shown in FIG. 20. The example device shown is a haptic cuff 900; the haptic cuff 900 can be controlled by a controller integrated into one or more electronic modules and attached to the conductive yarns. The haptic cuff 900 includes a contraction band 902 that can be designed to expand or contract an area of a garment. In one example, the haptic cuff 900 can be placed within the wrist cuff or ankle cuffs of a shirt or a pair of pants, respectively. Responsive to a touch-input from the wearer, the cuffs could expand or contract to suit the wearer's comfort needs. In another embodiment, a similar contraction band 902 could be placed around a user's waistband; for example, such a configuration would permit the style of a dress or shirt to be adjusted extemporaneously without requiring a private changing room or any awkward manipulations of the garment.

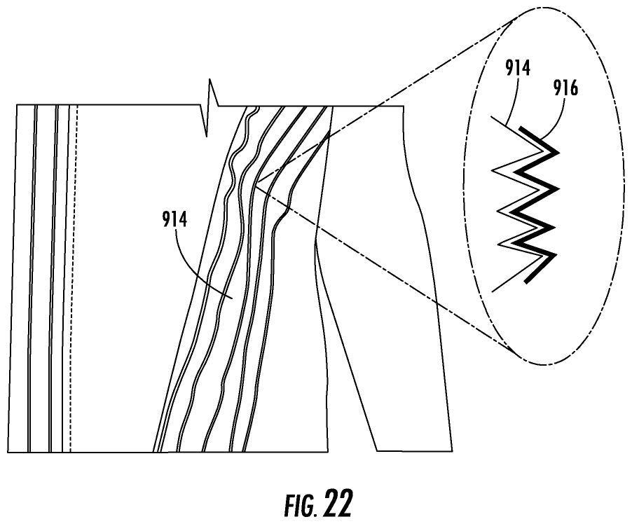

In another example, referring to FIGS. 21 and 22, one embodiment of a garment is illustrated that includes areas that can be expanded and retracted in response to interaction with a capacitive touch sensor. As shown in FIG. 21, the garment 910 includes a capacitive touch sensor 912. The user contacts the touch sensor with a particular motion or gesture. The input to the capacitive touch sensor 912 is communicated to an electronic module that then controls interactive features of the garment.

For instance, as shown in FIG. 22, the garment can include a plurality of pleats 914 that can expand or contract based upon the user input. As previously discussed, the pleats may be actuated by any number of materials which eliminate the need for a motor. For example, the fabric pleats 914 may be reinforced in certain portions by piezoelectric composite pleat actuators 916, where the fold of each pleat is formed at the intersection of two piezoelectric composite pleat actuators 916 of opposite electrical polarity. In such a configuration, the applied electrical field across the pleat actuators 916 will induce an accordion effect, collapsing or expanding the pleats 914.

A separate computing device, such as a smartphone, can monitor change in the garment and inform a user how much the garment has expanded or contracted. Based on the readings on the smartphone, the user can decide whether to further adjust the garment using the capacitive touch sensor 912.

According to some embodiments, actuated fabric tightening/loosening can be used as one or more of the tactile signals described above. For example, an interactive garment as illustrated in FIG. 20, FIG. 21, and/or FIG. 22 may be used provide an output response to user indicative of a vehicle-related notification. In one embodiment, an arm or other portion of the an interactive garment can provide a mild squeeze signal to the user's arm when the driver or vehicle arrives, in addition to (or as an alternative to) the vibrating cuff button. As another example, there can be a so-called “analog” relationship between the actuated arm squeezing and the location of the driver or vehicle, wherein the fabric tightening/squeezing increases gradually according to the declining distance between the driver or vehicle and the pickup point.

FIG. 23 illustrates various components of an example computing system 1000 that can be implemented as any type of client, server, and/or computing device as described with reference to the previous FIGS. 1-4 to implement an interactive object with multiple electronics modules. For example, computing system 1000 may correspond to removable electronics module 206 and/or embedded in interactive object 104. In embodiments, computing system 1000 can be implemented as one or a combination of a wired and/or wireless wearable device, System-on-Chip (SoC), and/or as another type of device or portion thereof. Computing system 1000 may also be associated with a user (e.g., a person) and/or an entity that operates the device such that a device describes logical devices that include users, software, firmware, and/or a combination of devices.

Computing system 1000 includes communication devices 1002 that enable wired and/or wireless communication of device data 1004 (e.g., received data, data that is being received, data scheduled for broadcast, data packets of the data, etc.). Device data 1004 or other device content can include configuration settings of the device, media content stored on the device, and/or information associated with a user of the device. Media content stored on computing system 1000 can include any type of audio, video, and/or image data. Computing system 1000 includes one or more data inputs 1006 via which any type of data, media content, and/or inputs can be received, such as human utterances, user-selectable inputs (explicit or implicit), messages, music, television media content, recorded video content, and any other type of audio, video, and/or image data received from any content and/or data source.

Computing system 1000 also includes communication interfaces 1008, which can be implemented as any one or more of a serial and/or parallel interface, a wireless interface, any type of network interface, a modem, and as any other type of communication interface. Communication interfaces 1008 provide a connection and/or communication links between computing system 1000 and a communication network by which other electronic, computing, and communication devices communicate data with computing system 1000.

Computing system 1000 includes one or more processors 1010 (e.g., any of microprocessors, controllers, and the like), which process various computer-executable instructions to control the operation of computing system 1000 and to enable techniques for, or in which can be embodied, interactive textiles. Alternatively or in addition, computing system 1000 can be implemented with any one or combination of hardware, firmware, or fixed logic circuitry that is implemented in connection with processing and control circuits which are generally identified at 1012. Although not shown, computing system 1000 can include a system bus or data transfer system that couples the various components within the device. A system bus can include any one or combination of different bus structures, such as a memory bus or memory controller, a peripheral bus, a universal serial bus, and/or a processor or local bus that utilizes any of a variety of bus architectures.

Computing system 1000 also includes computer-readable media 1014, such as one or more memory devices that enable persistent and/or non-transitory data storage (i.e., in contrast to mere signal transmission), examples of which include random access memory (RAM), non-volatile memory (e.g., any one or more of a read-only memory (ROM), flash memory, EPROM, EEPROM, etc.), and a disk storage device. A disk storage device may be implemented as any type of magnetic or optical storage device, such as a hard disk drive, a recordable and/or rewriteable compact disc (CD), any type of a digital versatile disc (DVD), and the like. Computing system 1000 can also include a mass storage media device 1016.

Computer-readable media 1014 provides data storage mechanisms to store device data 1004, as well as various device applications 1018 and any other types of information and/or data related to operational aspects of computing system 1000. For example, an operating system 1020 can be maintained as a computer application with computer-readable media 1014 and executed on processors 1010. Device applications 1018 may include a device manager, such as any form of a control application, software application, signal-processing and control module, code that is native to a particular device, a hardware abstraction layer for a particular device, and so on. Device applications 1018 also include any system components, engines, or managers to implement an interactive object with multiple electronics modules.

The technology discussed herein makes reference to servers, databases, software applications, and other computer-based systems, as well as actions taken and information sent to and from such systems. One of ordinary skill in the art will recognize that the inherent flexibility of computer-based systems allows for a great variety of possible configurations, combinations, and divisions of tasks and functionality between and among components. For instance, server processes discussed herein may be implemented using a single server or multiple servers working in combination. Databases and applications may be implemented on a single system or distributed across multiple systems. Distributed components may operate sequentially or in parallel.

While the present subject matter has been described in detail with respect to specific example embodiments thereof, it will be appreciated that those skilled in the art, upon attaining an understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

1. A computer-implemented method of facilitating vehicle related notifications in interactive systems, comprising:
receiving, by a computing system including one or more computing devices of an interactive object, data associated with a status of a vehicle that is providing a vehicle service associated with a user of the interactive object;
providing, by the one or more computing devices of the interactive object, one or more output signals to one or more output devices of the interactive object, wherein the one or more output signals are based at least in part on the data associated with the status of the vehicle; and
providing, by the one or more output devices of the interactive object in response to the one or more output signals, an output response indicative of the status of the vehicle.

2. The computer-implemented method of claim 1, wherein:
the one or more output signals include one or more context-sensitive signals indicative of the status of the vehicle.

3. The computer-implemented method of claim 1, wherein:
the interactive object includes an interactive textile.

4. The computer-implemented method of claim 1, wherein:
the interactive object is at least one of an interactive garment, an interactive garment accessory, or an interactive garment container.

5. The computer-implemented method of claim 1, wherein:
the one or more output devices includes a visual output device comprising one or more light-emitting diodes integrated with the interactive object.

6. The computer-implemented method of claim 1, wherein the one or more output signals are one or more first output signals and the output response is a first output response, the method further comprising:
receiving, by the computing system, data indicative of movement associated with the interactive object, wherein the movement is detected by one or more sensors of the interactive object;
detecting, by the computing system, at least one gesture based at least in part on the data indicative of the movement associated with the interactive object; and
in response to detecting the at least one gesture, receiving supplemental data associated with the vehicle; and
providing, in response to the supplemental data, one or more second output signals to the one or more output devices of the interactive object, wherein the one or more second output signals are based at least in part on the supplemental data associated with the vehicle
providing, by the one or more output devices of the interactive object in response to the one or more output signals, a second output response associated with the supplemental data associated with the vehicle.

7. The computer-implemented method of claim 6, wherein:
the one or more sensors include an inertial measurement unit; and
the data indicative of movement associated with the user of the interactive object is based on one or more outputs of the inertial measurement unit.

8. The computer-implemented method of claim 6, wherein:
the one or more sensors include a capacitive touch sensor comprising a set of conductive lines integrated with the interactive object; and
the data indicative of movement associated with the user of the interactive object is based on one or more outputs of the capacitive touch sensor.

9. The computer-implemented method of claim 1, wherein:
the data associated with the status of the vehicle includes data associated with a first status of the vehicle and data associated with a second status of the vehicle;
providing, by the one or more computing devices of the interactive object, one or more output signals comprises providing at least a first output signal based at least in part on the data associated with the first status of the vehicle and providing at least a second output signal based at least in part on the data associated with the second status of the vehicle; and
providing, by the one or more output devices of the interactive object in response to one or more output signals, the output response indicative of the status of the vehicle comprises providing a first output response indicative of the first status of the vehicle and providing a second output response indicative of the second status of the vehicle;
wherein the first output response is different from the second output response.

10. The computer-implemented method of claim 9, wherein:
the first status of the vehicle is associated with a first distance between the vehicle and the user; and
the second status of the vehicle is associated with a second distance between the vehicle and the user.

11. The computer-implemented method of claim 9, wherein:
the first output response includes a first visual indication provided by at least one visual output device of the one or more output devices of the interactive object; and
the second output response includes a second visual indication provided by the at least one visual output device of the one or more output devices of the interactive object.

12. The computer-implemented method of claim 9, wherein:
the first output response includes a first haptic output provided by at least one haptic device of the one or more output devices of the interactive object; and
the second output response includes a second haptic output provided by the at least one haptic device of the one or more output devices of the interactive object.

13. An interactive object, comprising
one or more output devices configured to generate one or more output responses that are perceptible to a user of the interactive object; and
one or more processors communicatively coupled to the one or more output devices, the one or more processors configured to receive data associated with a status of a vehicle that is providing a vehicle service associated with the user of the interactive object, the one or more processors configured to provide one or more output signals to the one or more output devices based at least in part on the data associated with the status of the vehicle;
wherein the one or more output devices are configured to provide an output response indicative of the status of the vehicle in response to the one or more output signals.

14. The interactive object of claim 13, wherein:
the one or more output devices include one or more haptic devices;
the data associated with the status of the vehicle includes data associated with a distance of the vehicle from the user of the interactive object;
the one or more output signals are based at least in part on the distance of the vehicle from the user of the interactive object; and
the one or more haptic devices provide a variable haptic output response based at least in part on the distance of the vehicle from the user of the interactive object.

15. The interactive object of claim 14, wherein:
the variable haptic output response includes a first haptic response level that is provided in response to a first vehicle distance and a second haptic response level that is provided in response to a second vehicle distance;
the first vehicle distance is less than the second vehicle distance; and
the first haptic response level is less than the second haptic response level.

16. The interactive object of claim 13, wherein the one or more output responses include a first output response, the interactive object further comprising:
one or more sensors configured to detect movement associated with the interactive object;
wherein the one or more processors are configured to:
receive data indicative of the movement detected by the one or more processors;
detect at least one gesture based at least in part on the data indicative of the movement detected by the one or more processors; and
in response to detecting the at least one gesture, receiving supplemental data associated with the vehicle;
wherein the one or more output devices are configured to provide at least a second output response based at least in part on the supplemental data associated with the vehicle.

17. The interactive object of claim 13, further comprising:
one or more sensors configured to detect movement associated with the interactive object;
wherein the one or more processors are configured to:
receive data indicative of the movement detected by the one or more processors;
detect at least one gesture based at least in part on the data indicative of the movement detected by the one or more processors; and
in response to detecting the at least one gesture, initiating one or more communications to at least one computing device associated with the vehicle.

18. A computing system for interfacing with an interactive object, comprising:
one or more processors; and
one or more non-transitory, computer-readable media that store instructions that when executed by the one or more processors cause the computing system to perform operations, the operations comprising:
receiving data associated with a status of a vehicle that is providing a vehicle service that is associated with a user of the interactive object;
determining one or more output responses for one or more output devices of the interactive object based at least in part on the data associated with status of the vehicle; and
transmitting one or more control signals to the interactive object to initiate the one or more output responses by the one or more output devices of the interactive object.

19. The computing system of claim 18, wherein the operations further comprise:
receiving data indicative of movement that is associated with the user of the interactive object, wherein the movement is detected by one or more sensors of the interactive object; and
transmitting to the interactive object, supplemental data associated with the vehicle in response to the data indicative of the movement that is associated with the user of the interactive object.

20. The computing system of claim 19, wherein:
the supplemental data includes identifying information for the vehicle.
